(19) United States
(12) Patent Application Publication
(10) Pub. No.: US 2026/0281449 A1
(43) Pub. Date: Sep. 17, 2026

(54) VIDEO CODING

(71) Applicant: Nokia Technologies Oy, Espoo (FI)

(72) Inventors: Jill BOYCE, Portland, OR (US); Miska Matias HANNUKSELA, Tampere (FI)

(21) Appl. No.: 19/340,721

(22) Filed: Sep. 25, 2025

Related U.S. Application Data
(60) Provisional application No. 63/770,082, filed on Mar. 11, 2025.

(51) Int. Cl. H04N 19/70

(52) U.S. Cl. CPC H04N 19/70

(57) ABSTRACT

An example apparatus comprising: at least one processor; and at least one memory storing instructions that, when executed by the at least one processor, cause the apparatus at least to perform: generating or defining an exact match syntax flag for indicating whether an exact match of a decoded picture sample value in an object mask coded picture and an object mask picture sample value associated with an object mask identifier is required to associate a sample position with the object mask identifier, wherein the object mask picture sample value is described in an information message; and including the exact match syntax flag in the information message.

### TECHNICAL FIELD

The examples and non-limiting embodiments relate generally to video processing.

### BACKGROUND

It is known to provide standardized formats for encoding, signaling, or decoding of media data.

### SUMMARY

Example 1: An apparatus comprising: at least one processor; and at least one memory storing instructions that, when executed by the at least one processor, cause the apparatus at least to perform: generating or defining an exact match syntax flag for indicating whether an exact match of a decoded picture sample value in an object mask coded picture and an object mask picture sample value associated with an object mask identifier is required to associate a sample position with the object mask identifier, wherein the object mask picture sample value is described in an information message; and including the exact match syntax flag in the information message.

Example 2: The apparatus of example 1, wherein the apparatus is further caused to perform: determining an object mask of an object to represent the auxiliary picture; assigning the object mask identifier for the object; determining the object mask picture sample value associated with the object mask identifier; forming an object mask source picture, in which a sample value of the sample position associated with the object mask is set to the object mask picture sample value; encoding the object mask source picture to form the object mask coded picture; and including the object mask coded picture and the information message in an bitstream.

Example 3: The apparatus of any of the examples 1 or 2, wherein when the exact match syntax flag comprises a first value for indicating an exact match, and wherein when the decoded picture sample value is equal to the object mask picture sample value, the sample position is determined to be associated with the object mask identifier.

Example 4: The apparatus of any of the previous examples, wherein when the exact match syntax flag comprises a second value that does not indicate an exact match, determining a range of sample values associated with the object mask identifier based on information in the information message, and wherein when the sample value is within the determined range, the sample position is determined to be associated with the object mask identifier.

Example 5: The apparatus of any of the examples 1 to 3, wherein when the exact match syntax flag is set to a second value that does not indicate an exact match, and wherein the apparatus is further caused to perform: determining a tolerance value for the object mask coded picture; and determining a range of sample values for the object mask identifier based on the object mask picture sample value and the tolerance value, and wherein when the sample value is within the determined range, the sample position is determined to be associated with the object mask identifier.

Example 6: The apparatus of example 5, wherein to determine the range of sample values for the object mask identifier, and wherein the apparatus is further caused to perform: setting a minimum value of the range to the object mask picture sample value minus the tolerance value; and setting a maximum value of the range to the object mask picture sample value plus the tolerance value.

Example 7: The apparatus of any of the examples 5 or 6, wherein the apparatus is further caused to perform: limiting the object mask picture sample value and the tolerance value ranges corresponding to different object mask identifiers to not overlap.

Example 8: The apparatus of example 3, wherein when the exact match syntax flag comprises the first value for indicating an exact match, and wherein the apparatus is further caused to perform: determining a range of sample values for the object mask identifier, wherein a minimum value of the range and a maximum value of the range are determined based on the object mask picture sample value, and wherein when the sample value is within the determined range, the sample position is determined to be associated with the object mask identifier.

Example 9: The apparatus of any of the examples 5 to 8, wherein the apparatus is further caused to perform: signaling an explicit range syntax flag intended to be used to determine when the minimum value of the range and the maximum value of the range are explicitly signaled or are intended to be determined by mapping allowable decoded sample values to a closest object mask picture sample value.

Example 10: The apparatus of any of the examples 5 to 8, wherein the apparatus is further caused to perform: generating syntax elements for the tolerance value and/or the minimum value of the range and the maximum value of the range.

Example 11: The apparatus of example 10, wherein the apparatus is further caused to perform: conditioning presence of the syntax elements for the tolerance value and/or the minimum value of the range and the maximum value of the range based on the value of the exact match syntax flag.

Example 12: The apparatus of any of the previous examples, wherein: the object mask coded picture comprises an auxiliary picture; the object mask picture sample value comprises an auxiliary sample value; and/or the information message comprises an object mask information message.

Example 13: The apparatus of example 12, wherein the apparatus is further caused to perform: signaling one of the following: the tolerance value per auxiliary picture layer, wherein an auxiliary layer comprises the auxiliary picture; the tolerance value per object mask identifier value in the auxiliary picture layer; or a single tolerance value for all auxiliary picture layers associated with a primary layer, wherein the primary layer comprises the primary picture.

Example 14: The apparatus of example 12, wherein the apparatus is further caused to perform: signaling the minimum value of the range and the maximum value of the range per object mask identifier value in the auxiliary picture layer.

Example 15: The apparatus of any of the previous examples, wherein the apparatus is further caused to perform: modifying signaling a bounding box width and a bounding box height to subtract a particular value from actual width and height of the bounding box, wherein the bounding box width and the bounding box height are indented to be used to restrict which sample positions are associated with the object mask identifier.

Example 16: The apparatus of example 15, wherein the apparatus is further caused to perform: signaling a bounding box position and bounding box size parameters, comprising the bounding box height and bounding box width, in units of chroma samples.

Example 17: The apparatus of any of the previous examples, wherein access units comprising a primary picture to which the information message applies also comprise a picture in an auxiliary layer described by the information message.

Example 18: The apparatus of any of the previous examples, wherein a width and a height of the object mask coded picture described by the information message are equal to width and height of a primary picture.

Example 19: An apparatus comprising: at least one processor; and at least one memory storing instructions that, when executed by the at least one processor, cause the apparatus at least to perform: receiving a bitstream comprising an object mask coded picture and information message; decoding the object mask coded picture to form an object mask decoded picture comprising a decoded picture sample value; decoding an exact match syntax flag comprised in the information message, wherein the exact match syntax flag indicates whether an exact match of the decoded picture sample value in the object mask decoded picture and an object mask picture sample value associated with an object mask identifier is required to associate a sample position with the object mask identifier, wherein the object mask picture sample value is described in the information message.

Example 20: The apparatus of example 19, wherein the apparatus is further caused to perform: comparing the decoded picture sample value to the object mask picture sample value described in the information message; and determining the sample position to be associated with the object mask identifier when the exact match syntax flag comprises a first value for indicating an exact match and when the decoded picture sample value is equal to the object mask picture sample value.

Example 21: The apparatus of any of the examples 19 or 20, wherein when the exact match syntax flag comprises a second value that does not indicate an exact match, and wherein the apparatus is further caused to perform: receiving or determining a range of sample values associated with the object mask identifier based on information received in the information message; and determining the sample position to be associated with the object mask identifier when the sample value is within the received or determined range.

Example 22: The apparatus of any of the examples 19 or 20, wherein when the exact match syntax flag is set to a second value that does not indicate an exact match, and wherein the apparatus is further caused to perform; receiving a tolerance value for the object mask coded picture; and receiving or determining a range of sample values for the object mask identifier based on the object mask picture sample value and the tolerance value; and when the sample value is within the determined range, determining the sample position to be associated with the object mask identifier.

Example 23: The apparatus of example 22, wherein to determine the range of sample values for the object mask identifier, and wherein the apparatus is further caused to perform: setting a minimum value of the range to the object mask picture sample value minus the tolerance value; and setting a maximum value of the range to the object mask picture sample value plus the tolerance value.

Example 24: The apparatus of any of the examples 22 or 23, wherein the object mask picture sample value and the tolerance value are constrained so that ranges corresponding to different object mask identifiers do not overlap.

Example 25: The apparatus of example 20, wherein when the exact match syntax flag comprises the first value for indicating an exact match, and wherein the apparatus is further caused to perform; determining a range of sample values for the object mask identifier, wherein determining the range comprises: determining a minimum value of the range and a maximum value of the range based on the object mask picture sample value; and determining the sample position to be associated with the object mask identifier, when the sample value is within the determined range.

Example 26: The apparatus of any of the examples 22 to 25, wherein the apparatus is further caused to perform; receiving an explicit range syntax flag; and using the explicit range syntax flag for determining when the minimum value of the range and the maximum value of the range are explicitly received or are to be derived by mapping allowable decoded sample values to a closest object mask picture sample value.

Example 27: The apparatus of any of the examples 22 to 25, wherein: the tolerance value and/or the minimum value of the range and the maximum value of the range are comprised in syntax elements.

Example 28: The apparatus of example 27, wherein presence of the syntax elements for the tolerance value and/or the minimum value of the range and the maximum value of the range are conditioned based on the value of the exact match syntax flag.

Example 29: The apparatus of any of the previous examples, wherein: the object mask coded picture an auxiliary picture; the object mask picture sample value comprises an auxiliary sample value; and/or the information message comprises an object mask information message.

Example 30: The apparatus of example 29, wherein the apparatus is further caused to perform: receiving one of the following: the tolerance value per auxiliary picture layer, wherein an auxiliary layer comprises the auxiliary picture; the tolerance value per object mask identifier value in the auxiliary picture layer; or a single tolerance value for all auxiliary picture layers associated with a primary layer, wherein the primary layer comprises the primary picture.

Example 31: The apparatus of example 29, wherein the apparatus is further caused to perform: receiving the minimum value of the range and the maximum value of the range per object mask identifier value in the auxiliary picture layer.

Example 32: The apparatus of any of the examples 19 to 31, wherein the apparatus is further caused to perform; receiving a modified bounding box width and a modified bounding box height, wherein a particular value is subtracted from actual width and height of the bounding box to obtain the modified bounding box width and the modified bounding box height; and using the bounding box width and the bounding box height to restrict which sample positions are associated with the object mask identifier.

Example 33: The apparatus of example 32, wherein the apparatus is further caused to perform: receiving a bounding box position and bounding box size parameters, comprising the bounding box height and bounding box width, in units of chroma samples.

Example 34: The apparatus of any of the examples 19 to 33, wherein access units comprising a primary picture to which the information message applies also comprise a picture in an auxiliary layer described by the information message.

Example 35: The apparatus of any of the examples 19 to 34, wherein a width and a height of the object mask coded picture described by the information message are equal to width and height of a primary picture.

Example 36: An apparatus comprising: at least one processor; and at least one memory storing instructions that, when executed by the at least one processor, cause the apparatus at least to perform: determining a tolerance value for an object mask coded picture; and determining a range of sample values for an object mask identifier based on the object mask picture sample value associated with the object mask identifier and the tolerance value, and wherein when the sample value is within the determined range, the sample position is determined to be associated with the object mask identifier.

Example 37: The apparatus of example 36, wherein to determine the range of sample values for the object mask identifier, and wherein the apparatus is further caused to perform: setting a minimum value of the range to the object mask picture sample value minus the tolerance value; and setting a maximum value of the range to the object mask picture sample value plus the tolerance value.

Example 38: An apparatus comprising: at least one processor; and at least one memory storing instructions that, when executed by the at least one processor, cause the apparatus at least to perform: determining a range of sample values for an object mask identifier, wherein determining the range comprises: determining a minimum value of the range and a maximum value of the range based on the object mask picture sample value associated with the object mask identifier, and wherein when the sample value is within the determined range, the sample position is determined to be associated with the object mask identifier.

Example 39: An apparatus comprising: at least one processor; and at least one memory storing instructions that, when executed by the at least one processor, cause the apparatus at least to perform: receiving a tolerance value for an object mask coded picture; and receiving or determining a range of sample values for the object mask identifier based on the object mask picture sample value associated with the object mask identifier and the tolerance value; and when the sample value is within the determined range, determining the sample position to be associated with the object mask identifier.

Example 40: The apparatus of example 39, wherein to determine the range of sample values for the object mask identifier, and wherein the apparatus is further caused to perform: setting a minimum value of the range to the object mask picture sample value minus the tolerance value; and setting a maximum value of the range to the object mask picture sample value plus the tolerance value.

Example 41: An apparatus comprising: at least one processor; and at least one memory storing instructions that, when executed by the at least one processor, cause the apparatus at least to perform; determining a range of sample values for an object mask identifier, wherein determining the range comprises: determining a minimum value of the range and a maximum value of the range based on an object mask picture sample value associated with the object mask identifier; and determining the sample position to be associated with the object mask identifier, when the sample value is within the determined range.

Example 42: An apparatus comprising: at least one processor; and at least one memory storing instructions that, when executed by the at least one processor, cause the apparatus at least to perform; modifying signaling a bounding box width and a bounding box height to subtract a particular value from actual width and height of the bounding box, wherein the bounding box width and the bounding box height are indented to be used to restrict which sample positions are associated with the object mask identifier; signaling bounding box size parameters comprising the bounding box height and the bounding box width.

Example 43: The apparatus is further caused to perform: signaling a bounding box position.

Example 44: The apparatus of any of the examples 42 or 43, wherein the bounding box height and the bounding box width is signaled in units of chroma samples.

Example 45: An apparatus comprising: at least one processor; and at least one memory storing instructions that, when executed by the at least one processor, cause the apparatus at least to perform; receiving a modified bounding box width and a modified bounding box height, wherein a particular value is subtracted from actual width and height of the bounding box to obtain the modified bounding box width and the modified bounding box height; using the bounding box width and the bounding box height to restrict which sample positions are associated with the object mask identifier.

Example 46: The apparatus of example 45, wherein the apparatus is further caused to perform: receiving a bounding box position and bounding box size parameters, comprising the bounding box height and bounding box width, in units of chroma samples.

Example 47: A method comprising: generating or defining an exact match syntax flag for indicating whether an exact match of a decoded picture sample value in an object mask coded picture and an object mask picture sample value associated with an object mask identifier is required to associate a sample position with the object mask identifier, wherein the object mask picture sample value is described in an information message; and including the exact match syntax flag in the information message.

Example 48: The method of example 47 further comprising: determining an object mask of an object to represent the auxiliary picture; assigning the object mask identifier for the object; determining the object mask picture sample value associated with the object mask identifier; forming an object mask source picture, in which a sample value of the sample position associated with the object mask is set to the object mask picture sample value; encoding the object mask source picture to form the object mask coded picture; and including the object mask coded picture and the information message in an bitstream.

Example 49: The method of any of the examples 47 or 48, wherein when the exact match syntax flag comprises a first value for indicating an exact match, and wherein when the decoded picture sample value is equal to the object mask picture sample value, the sample position is determined to be associated with the object mask identifier.

Example 50: The method of any of the examples 47 to 49, wherein when the exact match syntax flag comprises a second value that does not indicate an exact match, determining a range of sample values associated with the object mask identifier based on information in the information message, and wherein when the sample value is within the determined range, the sample position is determined to be associated with the object mask identifier.

Example 51: The method of any of the examples 47 to 49, wherein when the exact match syntax flag is set to a second value that does not indicate an exact match, and wherein the method is further caused to perform; determining a tolerance value for the object mask coded picture; and determining a range of sample values for the object mask identifier based on the object mask picture sample value and the tolerance value, and wherein when the sample value is within the determined range, the sample position is determined to be associated with the object mask identifier.

Example 52: The method of example 51, wherein to determine the range of sample values for the object mask identifier, and wherein the method further comprises: setting a minimum value of the range to the object mask picture sample value minus the tolerance value; and setting a maximum value of the range to the object mask picture sample value plus the tolerance value.

Example 53: The method of any of the examples 51 or 52 further comprising: limiting the object mask picture sample value and the tolerance value ranges corresponding to different object mask identifiers to not overlap.

Example 54: The method of example 49, wherein when the exact match syntax flag comprises the first value for indicating an exact match, and wherein the method further comprises: determining a range of sample values for the object mask identifier, wherein a minimum value of the range and a maximum value of the range are determined based on the object mask picture sample value, and wherein when the sample value is within the determined range, the sample position is determined to be associated with the object mask identifier.

Example 55: The method of any of the examples 51 to 54 further comprising: signaling an explicit range syntax flag intended to be used to determine when the minimum value of the range and the maximum value of the range are explicitly signaled or are intended to be determined by mapping allowable decoded sample values to a closest object mask picture sample value.

Example 56: The method of any of the examples 51 to 54 further comprising: generating syntax elements for the tolerance value and/or the minimum value of the range and the maximum value of the range.

Example 57: The method of example 56 further comprising: conditioning presence of the syntax elements for the tolerance value and/or the minimum value of the range and the maximum value of the range based on the value of the exact match syntax flag.

Example 58: The method of any of the examples 47 to 57, wherein: the object mask coded picture comprises an auxiliary picture; the object mask picture sample value comprises an auxiliary sample value; and/or the information message comprises an object mask information message.

Example 59: The method of example 58 further comprising: signaling one of the following: the tolerance value per auxiliary picture layer, wherein an auxiliary layer comprises the auxiliary picture; the tolerance value per object mask identifier value in the auxiliary picture layer; or a single tolerance value for all auxiliary picture layers associated with a primary layer, wherein the primary layer comprises the primary picture.

Example 60: The method of example 58 further comprising: signaling the minimum value of the range and the maximum value of the range per object mask identifier value in the auxiliary picture layer.

Example 61: The method of any of the examples 47 to 60 further comprising: modifying signaling a bounding box width and a bounding box height to subtract a particular value from actual width and height of the bounding box, wherein the bounding box width and the bounding box height are indented to be used to restrict which sample positions are associated with the object mask identifier.

Example 62: The method of example 61 further comprising: signaling a bounding box position and bounding box size parameters, comprising the bounding box height and bounding box width, in units of chroma samples.

Example 63: The method of any of the examples 47 to 62, wherein access units comprising a primary picture to which the information message applies also comprise a picture in an auxiliary layer described by the information message.

Example 64: The method of any of the examples 47 to 63, wherein a width and a height of the object mask coded picture described by the information message are equal to width and height of a primary picture.

Example 65: A method comprising: receiving a bitstream comprising an object mask coded picture and information message; decoding the object mask coded picture to form an object mask decoded picture comprising a decoded picture sample value; decoding an exact match syntax flag comprised in the information message, wherein the exact match syntax flag indicates whether an exact match of the decoded picture sample value in the object mask decoded picture and an object mask picture sample value associated with an object mask identifier is required to associate a sample position with the object mask identifier, wherein the object mask picture sample value is described in the information message.

Example 66: The method of example 65 further comprising; comparing the decoded picture sample value to the object mask picture sample value described in the information message; and determining the sample position to be associated with the object mask identifier when the exact match syntax flag comprises a first value for indicating an exact match and when the decoded picture sample value is equal to the object mask picture sample value.

Example 67: The method of any of the examples 65 or 66, wherein when the exact match syntax flag comprises a second value that does not indicate an exact match, and wherein the method is further caused to perform: receiving or determining a range of sample values associated with the object mask identifier based on information received in the information message; and determining the sample position to be associated with the object mask identifier when the sample value is within the received or determined range.

Example 68: The method of any of the examples 65 or 66, wherein when the exact match syntax flag is set to a second value that does not indicate an exact match, and wherein the method further comprises; receiving a tolerance value for the object mask coded picture; and receiving or determining a range of sample values for the object mask identifier based on the object mask picture sample value and the tolerance value; and when the sample value is within the determined range, determining the sample position to be associated with the object mask identifier.

Example 69: The method of example 68, wherein to determine the range of sample values for the object mask identifier, and wherein the apparatus is further caused to perform: setting a minimum value of the range to the object mask picture sample value minus the tolerance value; and setting a maximum value of the range to the object mask picture sample value plus the tolerance value.

Example 70: The method of any of the examples 68 or 69, wherein the object mask picture sample value and the tolerance value are constrained so that ranges corresponding to different object mask identifiers do not overlap.

Example 71: The method of example 66, wherein when the exact match syntax flag comprises the first value for indicating an exact match, and wherein the method further comprises; determining a range of sample values for the object mask identifier, wherein determining the range comprises: determining a minimum value of the range and a maximum value of the range based on the object mask picture sample value; and determining the sample position to be associated with the object mask identifier, when the sample value is within the determined range.

Example 72: The method of any of the examples 68 to 71 further comprising; receiving an explicit range syntax flag; and using the explicit range syntax flag for determining when the minimum value of the range and the maximum value of the range are explicitly received or are to be derived by mapping allowable decoded sample values to a closest object mask picture sample value.

Example 73: The method of any of the examples 68 to 71, wherein: the tolerance value and/or the minimum value of the range and the maximum value of the range are comprised in syntax elements.

Example 74: The method of example 73, wherein presence of the syntax elements for the tolerance value and/or the minimum value of the range and the maximum value of the range are conditioned based on the value of the exact match syntax flag.

Example 75: The method of any of the examples 65 to 74, wherein: the object mask coded picture an auxiliary picture; the object mask picture sample value comprises an auxiliary sample value; and/or the information message comprises an object mask information message.

Example 76: The method of example 75 further comprising: receiving one of the following: the tolerance value per auxiliary picture layer, wherein an auxiliary layer comprises the auxiliary picture; the tolerance value per object mask identifier value in the auxiliary picture layer; or a single tolerance value for all auxiliary picture layers associated with a primary layer, wherein the primary layer comprises the primary picture.

Example 77: The method of example 75 further comprising: receiving the minimum value of the range and the maximum value of the range per object mask identifier value in the auxiliary picture layer.

Example 78: The method of any of the examples 65 to 77 further comprising; receiving a modified bounding box width and a modified bounding box height, wherein a particular value is subtracted from actual width and height of the bounding box to obtain the modified bounding box width and the modified bounding box height; and using the bounding box width and the bounding box height to restrict which sample positions are associated with the object mask identifier.

Example 79: The method of example 78 further comprising: receiving a bounding box position and bounding box size parameters, comprising the bounding box height and bounding box width, in units of chroma samples.

Example 80: The method of any of the examples 65 to 79, wherein access units comprising a primary picture to which the information message applies also comprise a picture in an auxiliary layer described by the information message.

Example 81: The method of any of the examples 65 to 80, wherein a width and a height of the object mask coded picture described by the information message are equal to width and height of a primary picture.

Example 82: A method comprising: determining a tolerance value for an object mask coded picture; and determining a range of sample values for an object mask identifier based on the object mask picture sample value associated with the object mask identifier and the tolerance value, and wherein when the sample value is within the determined range, the sample position is determined to be associated with the object mask identifier.

Example 83: The method of example 82, wherein to determine the range of sample values for the object mask identifier, and wherein the method further comprises: setting a minimum value of the range to the object mask picture sample value minus the tolerance value; and setting a maximum value of the range to the object mask picture sample value plus the tolerance value.

Example 84: A method comprising: determining a range of sample values for an object mask identifier, wherein determining the range comprises: determining a minimum value of the range and a maximum value of the range based on the object mask picture sample value associated with the object mask identifier, and wherein when the sample value is within the determined range, the sample position is determined to be associated with the object mask identifier.

Example 85: A method comprising: receiving a tolerance value for an object mask coded picture; and receiving or determining a range of sample values for the object mask identifier based on the object mask picture sample value associated with the object mask identifier and the tolerance value; and when the sample value is within the determined range, determining the sample position to be associated with the object mask identifier.

Example 86: The method of example 85, wherein to determine the range of sample values for the object mask identifier, and wherein the method further comprises: setting a minimum value of the range to the object mask picture sample value minus the tolerance value; and setting a maximum value of the range to the object mask picture sample value plus the tolerance value.

Example 87: A method comprising: determining a range of sample values for an object mask identifier, wherein determining the range comprises: determining a minimum value of the range and a maximum value of the range based on an object mask picture sample value associated with the object mask identifier; and determining the sample position to be associated with the object mask identifier, when the sample value is within the determined range.

Example 88: A method comprising: modifying signaling a bounding box width and a bounding box height to subtract a particular value from actual width and height of the bounding box, wherein the bounding box width and the bounding box height are indented to be used to restrict which sample positions are associated with the object mask identifier; signaling bounding box size parameters comprising the bounding box height and the bounding box width.

Example 89: The method is further caused to perform: signaling a bounding box position.

Example 90: The method of any of the examples 88 or 89, wherein the bounding box height and the bounding box width is signaled in units of chroma samples.

Example 91: A method comprising: receiving a modified bounding box width and a modified bounding box height, wherein a particular value is subtracted from actual width and height of the bounding box to obtain the modified bounding box width and the modified bounding box height; using the bounding box width and the bounding box height to restrict which sample positions are associated with the object mask identifier.

Example 92: The method of example 91 further comprising: receiving a bounding box position and bounding box size parameters, comprising the bounding box height and bounding box width, in units of chroma samples.

Example 93: An apparatus comprising means for performing the methods as described in any of the examples 47 to 92.

Example 94: A computer readable medium comprising program instructions that, when executed by an apparatus, cause the apparatus at least to perform the methods as described in any of the examples 47 to 92.

Example 95: The computer readable medium of example 94, wherein the computer readable medium comprises a non-transitory computer readable medium.

### BRIEF DESCRIPTION OF THE DRAWINGS

The foregoing embodiments and other features are explained in the following description, taken in connection with the accompanying drawings, wherein:

FIG. 1 shows schematically an apparatus employing embodiments of the examples described herein.

FIG. 2 shows schematically a user equipment suitable for employing embodiments of the examples described herein.

FIG. 3 further shows schematically electronic devices employing embodiments of the examples described herein connected using wireless and wired network connections.

FIG. 4 is a block diagram illustrating a system in accordance with an example.

FIG. 5 shows an example primary picture.

FIG. 6 shows a source object mask auxiliary picture.

FIG. 7 shows magnified difference between source and compressed object mask auxiliary picture.

FIG. 8 shows an example the object mask information supplemental enhancement information (SEI) message, in accordance to an embodiment.

FIG. 9 shows an example implementation for variables OmiAuxSampleRangeDeltaMin[i] and OmiAuxSampleRangeDeltaMax[i].

FIG. 10 shows an example implementation or pseudo-code 1000 to map sample values to mask identifiers.

FIG. 11 shows an example signaling implementation, in accordance with an embodiment.

FIG. 12 shows example conditions, in accordance with an embodiment.

FIG. 13 shows an example implementation or pseudo code for mapping sample values to mask identifiers.

FIG. 14 shows an at least an excerpt of an example syntax table for signaling minimum and maximum values of sample value ranges

FIG. 15 shows an example implementation or pseudo code 1500 for mapping sample values to mask identifiers.

FIG. 16 shows an example implementation for deriving the variables OmiAuxSampleMin[i][j] and OmiAuxSampleMax[i][j].

FIG. 17 shows an example semantics for adapting the maximum value of the range, in accordance to an example embodiment.

FIG. 18 shows at least an excerpt of an example syntax table comprising omi_tolerance_present_flag and omi_aux_sample_tolerance[i].

FIG. 19 shows an example implementation or pseudo-code for mapping sample values to mask identifiers.

FIG. 20 shows an example implementation for signaling bounding box parameters.

FIG. 21 shows an example implementation for determining the mask area.

FIG. 22 shows an example implementation for deriving omiNumAuxLayer and omiAuxLayerId[i].

FIG. 23 is an example apparatus, which may be implemented in hardware, and is caused to, implement examples described herein.

FIG. 24 shows a representation of an example of non-volatile memory media used to store instructions that implement the examples described herein.

FIG. 25 is an example method performed with an encoder, based on the examples described herein.

FIG. 26 is an example method performed with an decoder, based on the examples described herein.

FIG. 27 is another example method performed with an encoder, based on the examples described herein.

FIG. 28 is another example method performed with an decoder, based on the examples described herein.

FIG. 29 is yet another example method performed with an encoder, based on the examples described herein.

FIG. 30 is yet another example method performed with an decoder, based on the examples described herein.

FIG. 31 is still another example method performed with an encoder, based on the examples described herein.

FIG. 32 is still another example method performed with an decoder, based on the examples described herein.

### DETAILED DESCRIPTION OF EXAMPLE EMBODIMENTS

The following acronyms and abbreviations that may be found in the specification and/or the drawing figures are defined as follows (the abbreviations may be appended with each other or with other characters using e.g. a hyphen or dash (-), and may be case insensitive):
5G fifth generation cellular network technology
DSP digital signal processor
HEVC high efficiency video coding
ID identifier
JVET joint video experts team
LTE long-term evolution
RFC request for comments
SEI supplemental enhancement information
VVC versatile video coding
VSEI versatile supplemental enhancement information

Some embodiments will now be described more fully hereinafter with reference to the accompanying drawings, in which some, but not all, embodiments may be shown. Indeed, various embodiments of the invention may be embodied in many different forms and should not be construed as limited to the embodiments set forth herein; rather, these embodiments are provided so that this disclosure will satisfy applicable legal requirements. Like reference numerals refer to like elements throughout. As used herein, the terms ‘data,’ ‘content,’ ‘information,’ and similar terms may be used interchangeably to refer to data capable of being transmitted, received and/or stored in accordance with embodiments of the present invention. Thus, use of any such terms should not be taken to limit the spirit and scope of embodiments.

Described herein is a method and apparatus for using an object mask information message for lossy coding.

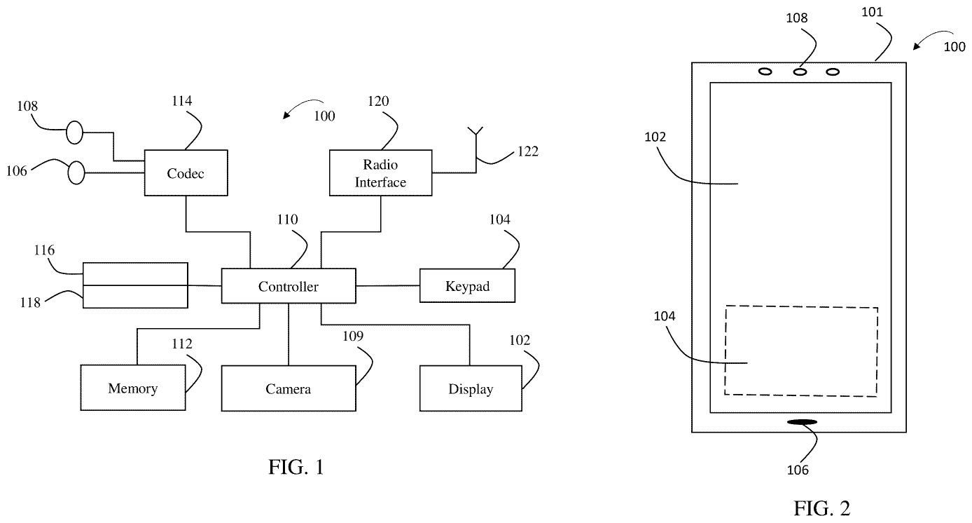

The following describes in detail a suitable apparatus and possible method for using an object mask information message for lossy coding according to embodiments. In this regard reference is first made to FIG. 1 and FIG. 2, where FIG. 1 shows an example block diagram of an electronic device or apparatus 100. The apparatus 100 may be an Internet of Things (IoT) apparatus configured to perform various functions, such as for example, gathering information by one or more sensors, receiving or transmitting information, analyzing information gathered or received by the apparatus, or the like. The apparatus may comprise a video coding system, which may incorporate a codec. FIG. 2 shows a layout of an apparatus according to an example embodiment. The elements of FIG. 1 and FIG. 2 are explained next.

The apparatus 100 may for example be a mobile terminal or user equipment of a wireless communication system, a sensor device, a tag, or other lower power device. However, it would be appreciated that embodiments of the examples described herein may be implemented within any electronic device or apparatus which may process data by neural networks.

The apparatus 100 may comprise a housing 101 for incorporating and protecting the device. The apparatus 100 further may comprise a display 102 in the form of a liquid crystal display. In other embodiments of the examples described herein the display may be any suitable display technology suitable to display an image or video. The apparatus 100 may further comprise a keypad 104. In other embodiments of the examples described herein any suitable data or user interface mechanism may be employed. For example the user interface may be implemented as a virtual keyboard or data entry system as part of a touch-sensitive display.

The apparatus may comprise a microphone 106 or any suitable audio input which may be a digital or analog signal input. The apparatus 100 may further comprise an audio output device which in embodiments of the examples described herein may be any one of: an earpiece 108, speaker, or an analog audio or digital audio output connection. The apparatus 100 may also comprise a battery (or in other embodiments of the examples described herein the device may be powered by any suitable mobile energy device such as solar cell, fuel cell or clockwork generator). The apparatus 100 may further comprise a camera 109 capable of recording or capturing images and/or video. The apparatus 100 may further comprise an infrared port for short range line of sight communication to other devices. In other embodiments the apparatus 100 may further comprise any suitable short range communication solution such as for example a Bluetooth wireless connection or a USB/firewire wired connection.

The apparatus 100 may comprise a controller 110, processor or processor circuitry for controlling the apparatus 100. The controller 110 may be connected to memory 112 which in embodiments of the examples described herein may store both data in the form of image and audio data and/or may also store instructions for implementation on the controller 110. The controller 110 may further be connected to codec circuitry 114 suitable for carrying out coding and/or decoding of audio and/or video data or assisting in coding and/or decoding carried out by the controller.

The apparatus 100 may further comprise a card reader 118 and a smart card 116, for example a UICC and UICC reader for providing user information and being suitable for providing authentication information for authentication and authorization of the user at a network.

The apparatus 100 may comprise radio interface circuitry 120 connected to the controller and suitable for generating wireless communication signals for example for communication with a cellular communications network, a wireless communications system or a wireless local area network. The apparatus 100 may further comprise an antenna 122 connected to the radio interface circuitry 120 for transmitting radio frequency signals generated at the radio interface circuitry 120 to other apparatus(es) and/or for receiving radio frequency signals from other apparatus(es).

The apparatus 100 may comprise a camera capable of recording or detecting individual frames which are then passed to the codec circuitry 114 or the controller for processing. The apparatus may receive the video image data for processing from another device prior to transmission and/or storage. The apparatus 100 may also receive either wirelessly or by a wired connection the image for coding/decoding. The structural elements of apparatus 100 described above represent examples of means for performing a corresponding function.

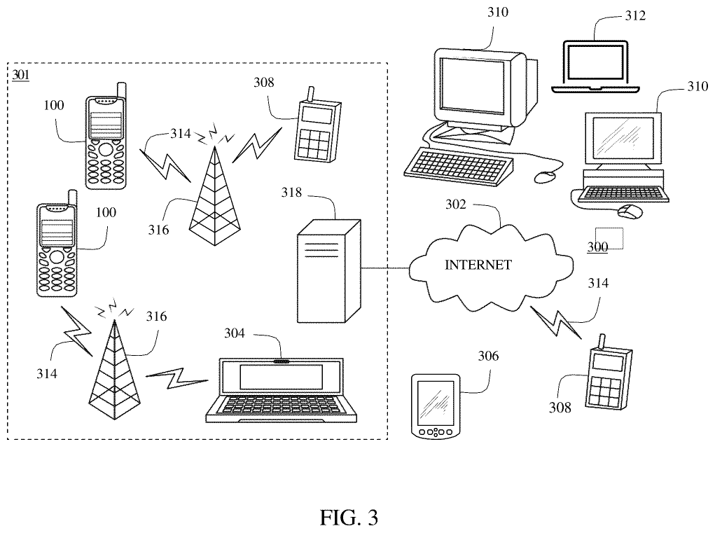

With respect to FIG. 3, an example of a system within which embodiments of the examples described herein can be utilized is shown. The system 300 comprises multiple communication devices which can communicate through one or more networks. The system 300 may comprise any combination of wired or wireless networks including, but not limited to a wireless cellular telephone network (such as a GSM, UMTS, CDMA, LTE, 4G, 5G network, etc.), a wireless local area network (WLAN) such as defined by any of the IEEE 802.x standards, a Bluetooth personal area network, an Ethernet local area network, a token ring local area network, a wide area network, and the Internet.

The system 300 may include both wired and wireless communication devices and/or apparatus 100 suitable for implementing embodiments of the examples described herein.

For example, the system shown in FIG. 3 shows a mobile telephone network 301 and a representation of the internet 302. Connectivity to the internet 302 may include, but is not limited to, long range wireless connections, short range wireless connections, and various wired connections including, but not limited to, telephone lines, cable lines, power lines, and similar communication pathways.

The example communication devices shown in the system 300 may include, but are not limited to, an electronic device or apparatus 100, a combination of a personal digital assistant (PDA) and a mobile telephone 304, a PDA 306, an integrated messaging device (IMD) 308, a desktop computer 310, a notebook computer 312, or a head-mounted apparatus. The head-mounted apparatus may be a head-mounted display (HMD), or glasses having a device such as a camera configured to encode and/or decode images and/or video. The apparatus 100 may be stationary or mobile when carried by an individual who is moving. The apparatus 100 may also be located in a mode of transport including, but not limited to, a car, a truck, a taxi, a bus, a train, a boat, an airplane, a bicycle, a motorcycle or any similar suitable mode of transport.

The embodiments may also be implemented in a set-top box; e.g., a digital TV receiver, which may/may not have a display or wireless capabilities, in tablets or (laptop) personal computers (PC), which have hardware and/or software to process neural network data, in various operating systems, and in chipsets, processors, DSPs and/or embedded systems offering hardware/software based coding.

Some or further apparatus may send and receive calls and messages and communicate with service providers through a wireless connection 314 to a base station 316. The base station 316 may be connected to a network server 318 that allows communication between the mobile telephone network 301 and the internet 302. The system may include additional communication devices and communication devices of various types.

The communication devices may communicate using various transmission technologies including, but not limited to, code division multiple access (CDMA), global systems for mobile communications (GSM), universal mobile telecommunications system (UMTS), time divisional multiple access (TDMA), frequency division multiple access (FDMA), transmission control protocol-internet protocol (TCP-IP), short messaging service (SMS), multimedia messaging service (MMS), email, instant messaging service (IMS), Bluetooth, IEEE 802.11, 3GPP Narrowband IoT and any similar wireless communication technology. A communications device involved in implementing various embodiments of the examples described herein may communicate using various media including, but not limited to, radio, infrared, laser, cable connections, and any suitable connection.

In telecommunications and data networks, a channel may refer either to a physical channel or to a logical channel. A physical channel may refer to a physical transmission medium such as a wire, whereas a logical channel may refer to a logical connection over a multiplexed medium, capable of conveying several logical channels. A channel may be used for conveying an information signal, for example a bitstream, from one or several senders (or transmitters) to one or several receivers.

The embodiments may also be implemented in so-called IoT devices. The Internet of Things (IoT) may be defined, for example, as an interconnection of uniquely identifiable embedded computing devices within the existing Internet infrastructure. The convergence of various technologies has and may enable many fields of embedded systems, such as wireless sensor networks, control systems, home/building automation, etc. to be included in the Internet of Things (IoT). In order to utilize the Internet IoT devices are provided with an IP address as a unique identifier. IoT devices may be provided with a radio transmitter, such as a WLAN or Bluetooth transmitter or a RFID tag. Alternatively, IoT devices may have access to an IP-based network via a wired network, such as an Ethernet-based network or a power-line connection (PLC).

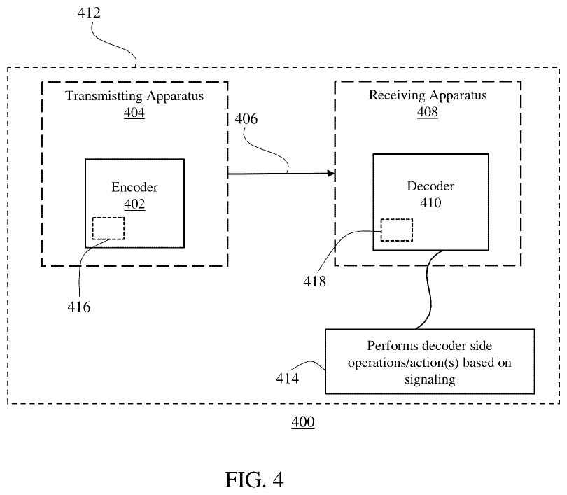

FIG. 4 is a block diagram illustrating a system or apparatus 400 in accordance with several examples. In an example, the encoder 402 is used to encode an image or video, and the encoder 402 may be implemented in a transmitting apparatus 404. The encoder 402 produces a bitstream 406 comprising signaling that is received by the receiving apparatus 408, which implements a decoder 410. The encoder 402 sends the bitstream 406 that comprises the herein described signaling. The decoder 410 forms the image or video, and the receiving apparatus 408 may present this to the user, e.g., via a smartphone, television, or projector among many other options.

In some examples, the encoder 402 may reside in a separate apparatus from the transmitting apparatus 404. In some examples, the apparatus comprising the encoder 402 may be connected to the transmitting apparatus 404, e.g., through a memory bus. In some examples, the encoder 402 may produce the bitstream 406 that is stored, e.g. in a mass memory.

In some examples, the decoder 410 may reside in a separate apparatus from the receiving apparatus 408. In some examples, the apparatus comprising the decoder 410 may be operationally connected to the receiving apparatus 408, e.g., through a memory bus. In some examples, the decoder 410 may obtain the bitstream 406 from a mass memory.

In some examples, the transmitting apparatus 404 and the receiving apparatus 408 are at least partially within a common apparatus, and for example, are located within a common housing 412. For example, the common apparatus comprising the encoder 402 and decoder 410 implements a codec. In other examples, the encoder 402 and the decoder 410 are at least partially not within a common apparatus and have at least partially different housings, but when together, may still implement a codec.

As indicated at 414, the decoder 410 performs an operation(s) or action(s) based on the received signaling.

In some examples, encoding 416 performs encoding and/or signaling object mask information message, based on example described herein. In some examples, decoding 418 performs receiving and/or decoding object mask information message, based on the examples described herein.

Having thus introduced a suitable but non-limiting technical context for the practice of the example embodiments of the present disclosure, example embodiments will now be described in detail.

VSEI version 4 in JVET-AK2006-v1 includes an object mask information (OMI) SEI message. Sample values of coded pictures in one or more auxiliary layers are used to identify locations of objects in the associated primary layer coded picture.

The OMI SEI message includes signaling of an auxiliary sample value syntax element for each of one or more object mask ID values in an auxiliary picture, used to associate sample positions in the decoded auxiliary picture with an object mask ID.

omi_aux_sample_value[i][j] specifies the luma value of the samples corresponding to the area of the j-th object mask of the i-th object mask auxiliary layer associated with the current primary layer.

The OMI SEI message includes signaling of the top and left position; and width and height sizes of a rectangular bounding box that bounds the sample positions that may be associated with an object mask ID.

JVET contribution JVET-AF0087 conducted experiments with encoding auxiliary pictures containing object masks, for both lossless and lossy coding. It described an example in which all possible sample values of the decoded picture were mapped to an object mask ID, as determined by the closest value of the auxiliary sample value syntax element, omi_aux_sample_value[i][j].

The OMI SEI message semantics define a process to associate sample positions of an auxiliary picture to object mask IDs by comparing the decoded auxiliary picture samples to auxiliary sample values signaled for the mask ID for that auxiliary picture. The process requires an exact match between the decoded sample value and the omi_aux_sample_valu[i][j] signaled for a particular object mask ID to determine that an (x, y) sample position is associated with that object mask.

Requiring an exact match of a decoded sample value is not robust to lossy compression.

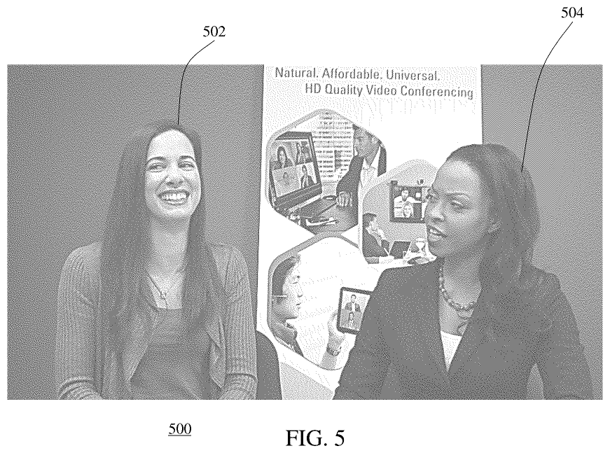

FIG. 5 shows an example primary picture 500. The example picture 500 in includes two women 502 and 504.

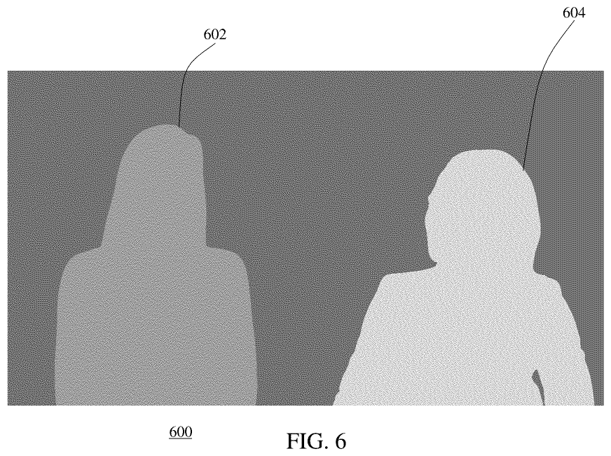

FIG. 6 shows an uncompressed source auxiliary picture 600 showing object masks with each of the two women 502 and 504 identified as separate objects 602 and 604.

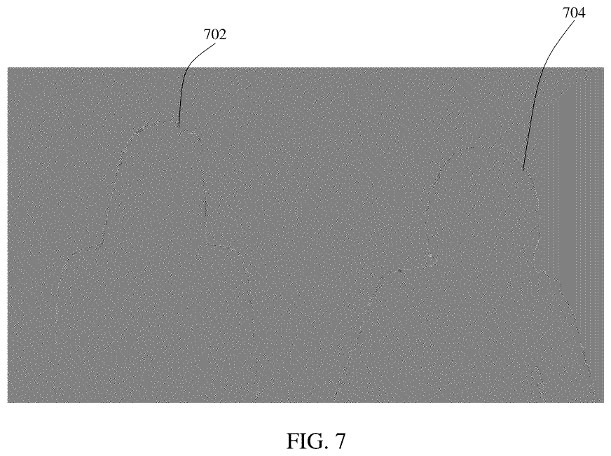

FIG. 7 shows the difference between the uncompressed vs. compressed auxiliary picture, coded using the x.265 encoder implementation of HEVC with quantization parameter (QP=16), with the difference magnified by a factor of 20 for easier visibility. The samples near the edges of the object masks 702 and 704 show differences.

While the AVC, HEVC, and VVC standards include tools that enable lossless compression, many encoder implementations do not support this feature. Coding efficiency is also greatly reduced when lossless compression is used.

Some example use cases for object masks would benefit from greater robustness to lossy compression, such as object replacement, object removal, or image reprojection to novel viewpoints.

However, some other example use cases may prefer having a strict mapping of the object sample value as provided by the current design, particularly when not all sample positions in a picture are assigned to an object.

The OMI SEI message is modified to add an exact match syntax flag to indicate when an exact match of the decoded picture sample in an auxiliary picture and the signaled values associated with the mask ID is required to associate the (x, y) sample position with the object mask ID.

Several embodiments are provided to determine a range of sample values mapped to an object mask ID.

A receiver/decoder decodes the auxiliary picture and compares the decoded auxiliary picture sample value at each (x, y) position to the sample values mapped to an object mask ID value, and determine that the (x, y) position is associated with an object mask ID value when the decoded sample value is within the range of sample values mapped to that object mask ID.

In an embodiment, a sample tolerance value is signaled per auxiliary picture layer.

In another embodiment, a sample tolerance value is signaled per object mask ID value in an auxiliary picture layer.

In yet another embodiment, a single sample tolerance value is signaled for all auxiliary picture layers associated with the same primary layer.

In an embodiment, range minimum and maximum sample values are signaled per object mask ID value in an auxiliary picture layer.

In an embodiment, when the exact match syntax flag indicates exact match, the range minimum and maximum values are derived based on the auxiliary sample values.

In an embodiment, an explicit range syntax flag is signaled to determine if the range minimum and maximum sample values are explicitly signaled or derived by mapping all allowable decoded sample values to the closest auxiliary sample value.

In some embodiments, the presence of the syntax elements for tolerance value and/or range minimum and maximum are conditioned on the value of the exact match syntax flag.

In an embodiment, the bounding box width and height signaling is modified to subtract one from actual width and height.

In an embodiment, the bounding box position and size parameters are signaled in units of chroma samples.

In an embodiment, a constraint is applied that all AUs comprising a primary picture where an object mask information message applies shall also include a picture in all associated object mask auxiliary layers described by the object mask information message.

In an embodiment, a constraint is applied that the width and height of auxiliary pictures described by an object mask information message are equal to the width and height, respectively, of an associated primary picture.

In an embodiment, an exact match syntax flag is added to an information message used to carry object mask or segmentation information, referred to as an object mask information message. The object mask information message may be included in a video bitstream with a coded picture representing an object mask, whose sample values are used to map a sample position with an object mask identifier. The object mask coded picture may be an auxiliary picture carried in an auxiliary layer that is associated with a primary coded picture that is also included in the bitstream in a separate layer. One or more object mask coded pictures may be included in the bitstream in separate layers.

An encoder determines a number of object masks to represent in the object mask coded picture, and for each object assigns an object mask identifier and determines an associated object mask picture sample value. The encoder forms an object mask source picture in which it sets the sample value of each sample position associated with an object mask to the object mask picture sample value, which may also be referred to as an auxiliary sample value. The encoder encodes the picture to form the object mask coded picture, and includes the object mask coded picture in the bitstream with the object mask information message.

In an embodiment, an explicit range syntax flag is added to an information message to indicate whether minimum and maximum values of the sample value range of sample values for an object mask identifier are explicitly signaled or derived.

Some embodiments are described below in relation to an exact match syntax flag. It is to be understood that embodiments may be similarly realized in relation to an explicit range syntax flag. For example, in an embodiment, when the explicit range syntax flag is set to a particular value, such as 1, that indicates a presence of syntax element(s) indicative of a range of sample values for each object mask identifier in the information message, a tolerance value is signaled for the object mask coded picture. The range of sample values for each object mask identifier is determined using the corresponding auxiliary sample value and the tolerance value. When the explicit range syntax flag is set to another particular value, such as 0, that indicates an absence of syntax element(s) indicative of a range of sample values for each object mask identifier in the information message. For example, when the explicit range syntax flag is set to another particular value, such as 0, a tolerance value is not signaled and the tolerance value may be inferred to be equal to 0, which indicates an exact match, which may be defined so that only when the decoded sample is equal to an auxiliary sample value for an object mask identifier, the sample position is determined to be associated with the corresponding object mask identifier.

In an embodiment, when an encoder sets the value of the exact match syntax flag in the object mask information message to a particular value to indicate an exact match, such as 1, and signals a number of object masks represented in the object mask coded picture, and signals an object mask identifier for each of the number of object masks.

A decoder receives the bitstream and decodes the object mask coded picture to form an object mask decoded picture, which includes decoded samples.

When the exact match syntax flag has a particular value indicating an exact match, such as 1, the receiver/decoder decodes the object mask coded picture, and for each decoded sample compares the decoded sample value to the auxiliary sample values described in the object mask information message. When the decoded sample is equal to an auxiliary samples value, the sample position is determined to be associated with the corresponding object mask identifier.

When the exact match syntax flag value does not indicate an exact match, e.g. has a different value such as 0, the receiver/decoder determines a range of sample values associated with each object mask identifier, based upon information signaled in the object mask information message. For each decoded sample, the decoder compares the decoded sample value to the determined range of sample values for an object mask identifier, and when the sample value is within the determined range, determines that the sample position is associated with the corresponding object mask identifier.

In an embodiment, when the exact match syntax flag is set to a value that does not indicate an exact match, a tolerance value is signaled for the object mask coded picture. The range of sample values for each object mask identifier is determined using the corresponding auxiliary sample value and the tolerance value.

In an embodiment, when the exact match syntax flag is set to 0, a tolerance value is signaled for the object mask coded picture. The range of sample values for each object mask identifier is determined using the corresponding auxiliary sample value and the tolerance value.

In an embodiment, the tolerance value is used to determine a value to be subtracted from the auxiliary sample value to obtain the minimum value of the range.

In an embodiment, the tolerance value is used to determine a value to be added to the auxiliary sample value to obtain the maximum value of the range.

In an embodiment, the range of sample values is determined by setting the minimum value of the range to the auxiliary sample value minus the tolerance value, and the maximum value to the auxiliary sample value plus the tolerance value.

In an embodiment, the range of sample values is determined by setting the minimum value of the range to the auxiliary sample value minus the tolerance value, and the maximum value to the auxiliary sample value plus the tolerance value minus 1.

In an embodiment, a bitstream constraint is placed on auxiliary sample values and tolerance values so that the ranges corresponding to different object mask identifiers do not overlap.

### Proposed Syntax and Semantics

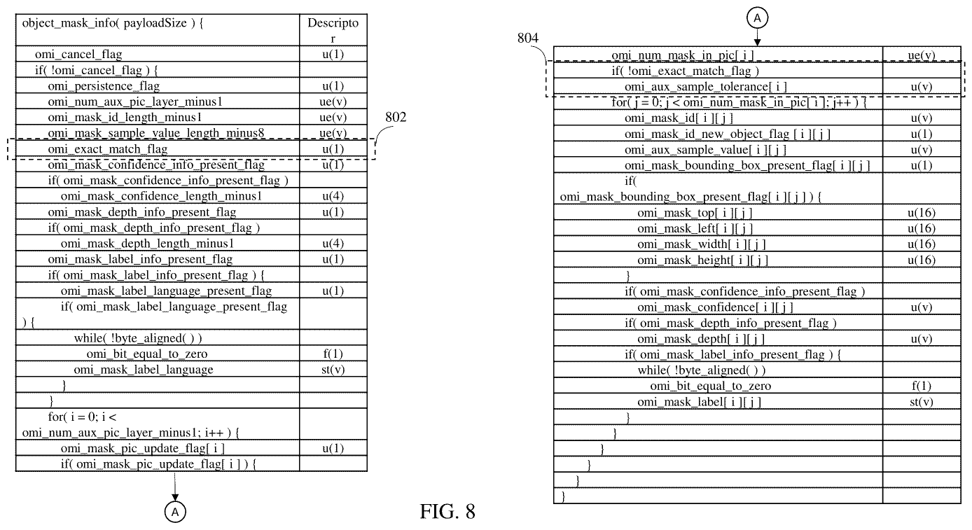

FIG. 8 shows an example the object mask information SEI message, in accordance to an embodiment. Modifications to the syntax and semantics of the object mask information SEI message of JVET-AK2006-v2 are shown in 802 and 804. In this example, the modified object mask information SEI message includes introducing new elements omi_exact_match_flag and omi_aux_sample_tolerance[i] and are described below:

omi_exact_match_flag equal to 1 specifies that the omi_aux_sample_tolerance[i] syntax element is present. omi_mask_exact_match_flag equal to 0 specifies that the omi_aux_sample_tolerance[i] syntax elements is not present.

omi_mask_sample_value_length_minus8 plus 8 specifies the length, in bits, of the omi_aux_sample_value[i][j] and omi_aux_sample_tolerance[i] syntax elements. The value of omi_mask_sample_value_length_minus8 shall be in the range of 0 to 8, inclusive. The value of omi_mask_sample_value_length_minus8 plus 8 shall be less than or equal to BitDepth_{Y}.

omi_aux_sample_tolerance[i] specifies a tolerance range for mapping of decoded sample values of the i-th auxiliary picture to object masks. The length of syntax element is omi_mask_sample_value_length_minus8 plus 8 bits. When not present, the value of omi_aux_sample_tolerance[i] is inferred to be equal to 0.

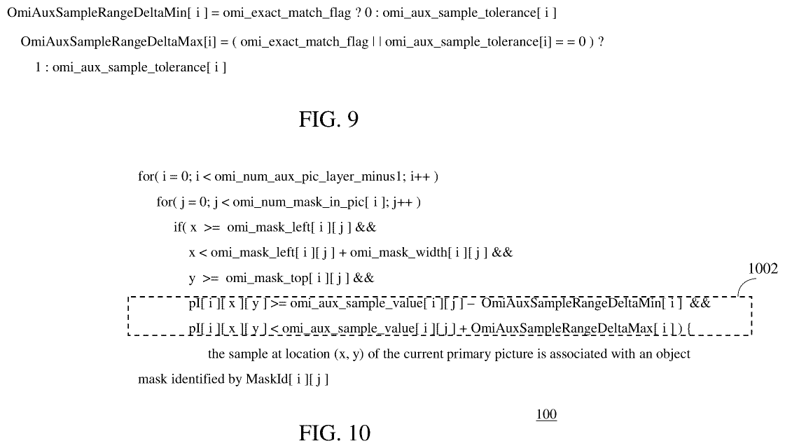

FIG. 9 shows an example implementation for deriving variables OmiAuxSampleRangeDeltaMin[i] and OmiAuxSampleRangeDeltaMax[i].

It is a requirement of bitstream conformance that when j is greater than 0, omi_aux_sample_value[i][j]−OmiAuxSampleRangeDeltaMin[i] shall be greater than or equal to omi_aux_sample_value[i][j−1]+OmiAuxSampleRangeDeltaMax[i].

FIG. 10 shows an example implementation or pseudo-code 1000 to map sample values to mask identifiers. 1002 requires the bitstream conformance described in this paragraph to be true in order to make the pseudo-code 1000 work.

### Additional Example Embodiments for Lossy Compression Range Determination

### Example Option 1: Signal omi_aux_pample_min[i][j] and omi_aux_sample_max[i][i]

In this embodiment, the sample value range minimum and maximum values are explicitly signaled when the exact match syntax flag is not set, and the auxiliary sample value is not signaled.

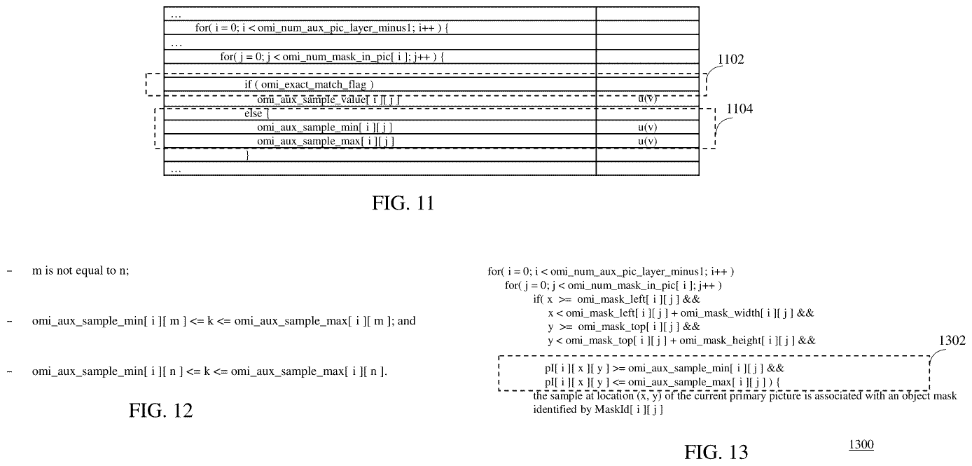

Referring to FIG. 11 it shows an example signaling implementation, in accordance with an embodiment. This includes introducing new elements shown at 1102 and 1104.

In an embodiment, a semantic constraint is imposed to require that ranges do not overlap for separate object mask identifier values.

In an embodiment, the semantics of the syntax elements related to FIG. 11 are described as follows.

omi_exact_match_flag equal to 1 specifies that the omi_aux_sample_value[i][j] syntax elements are present. omi_mask_exact_match_flag equal to 0 specifies that the omi_aux_sample_min[i][j] and omi_aux_sample_max[i][j] syntax elements are not present.

omi_mask_sample_value_length_minus8 plus 8 specifies the length, in bits, of the omi_aux_sample_value[i][j], omi_aux_sample_min[i][j], and omi_aux_sample_max[i][j] syntax elements. The value of omi_mask_sample_value_length_minus8 shall be in the range of 0 to 8, inclusive. The value of omi_mask_sample_value_length_minus8 plus 8 shall be less than or equal to BitDepth_{Y}.

omi_aux_sample_min[i][j] and omi_aux_sample_max[i][j] specify the minimum and maximum values, respectively, of a range for mapping of decoded sample values of the i-th auxiliary picture to the j-th object mask. The length of syntax elements are omi_mask_sample_value_length_minus8 plus 8 bits. When not present, the value of omi_aux_sample_min[i][j] and omi_aux_sample_max[i][j] are inferred to be equal to omi_aux_sample_value[i][j].

In an embodiment, the semantic constraint that ranges do not overlap for separate object mask identifier values is realized by requiring that, there shall be no values of k, i, m, and n such that all of the example conditions shown in FIG. 12 apply.

FIG. 13 shows an example implementation or pseudo-code 1300 for mapping sample values to mask identifiers. 1302 requires the example conditions described in FIG. 12 to be imposed for the pseudo-code 1300 to work.

### Example Option 2: Replace omi_aux_sample_value[i][j] with omi_aux_sample_min[i][j] and omi_aux_sample_max[i][j] or Derived Range

This embodiment signals an explicit range flag to indicate whether minimum and maximum values of the sample range are explicitly signaled or derived.

When the exact match syntax flag is set to 0 or the explicit range flag is set to 0, the auxiliary sample values are signaled for each object mask. In this case the range for a particular auxiliary sample value is derived to have the minimum value of the range be halfway between the distance between the particular auxiliary sample value and the auxiliary sample value with the next lower index or to 0 when there is no lower index, and the maximum value of the range is halfway between the distance between the particular auxiliary sample value and the auxiliary sample value with the next higher index value or to the highest possible sample value when there is no higher index. The highest possible sample value is determined by the bit depth of the auxiliary coded picture, 2\hat{ }BitDepth.

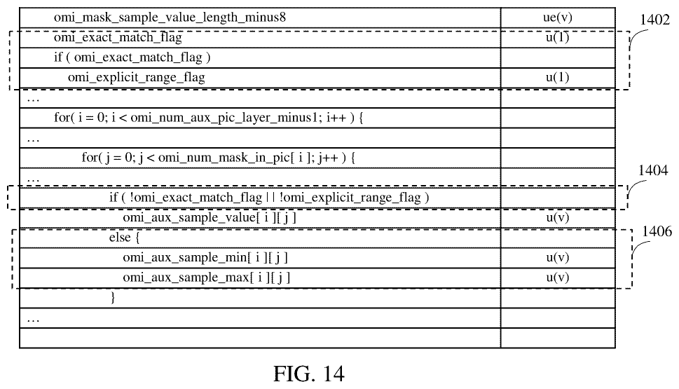

FIG. 14 shows an at least an excerpt of an example syntax table for signaling minimum and maximum values of sample value ranges. The modifications to the example syntax table are shown at 1402, 1404, and 1406. This includes introducing new elements omi_exact_match_flag and omi_aux_sample_tolerance[i], as described below:

omi_mask_sample_value_length_minus8 plus 8 specifies the length, in bits, of the omi_aux_sample_value[i][j], omi_aux_sample_min[i][j], and omi_aux_sample_max[i][j] syntax elements. The value of omi_mask_sample_value_length_minus8 shall be in the range of 0 to 8, inclusive. The value of omi_mask_sample_value_length_minus8 plus 8 shall be less than or equal to BitDepthY.

omi_aux_sample_min[i][j] and omi_aux_sample_max[i][j] specify the minimum and maximum values, respectively, of a range for mapping of decoded sample values of the i-th auxiliary picture to the j-th object mask. The length of syntax elements are omi_mask_sample_value_length_minus8 plus 8 bits.

There shall be no values of k, i, m, and n such that all of the following example shown in FIG. 12 apply.

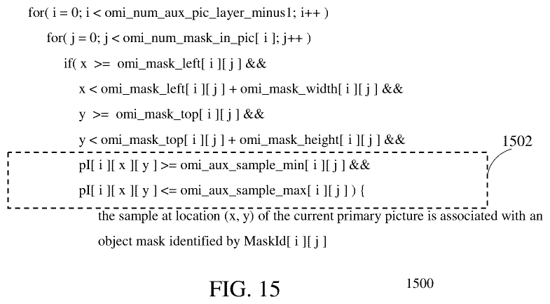

FIG. 15 shows an example implementation or pseudo code 1500 for mapping sample values to mask identifiers. 1502 requires the example conditions described in FIG. 12 to be imposed for the pseudo code 1500 to work.

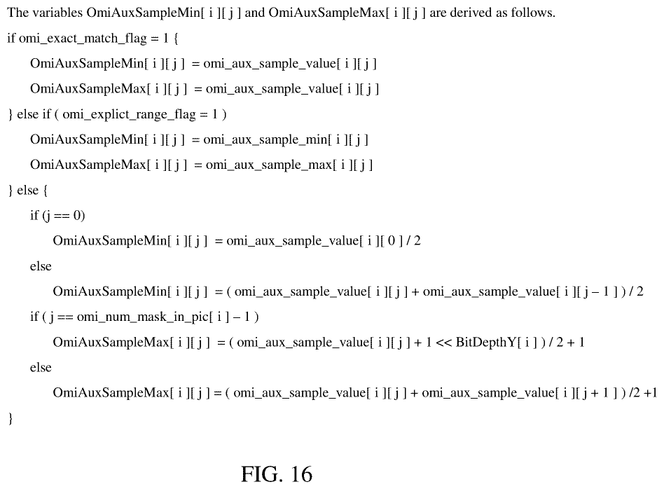

FIG. 16 shows an example implementation for deriving the variables OmiAuxSampleMin[i][j] and OmiAuxSampleMax[i][j].

### Example Option 3

In an embodiment, the syntax presented in FIG. 8 is used, but instead of a bitstream constraint on auxiliary sample values and tolerance values so that the ranges corresponding to different object mask identifiers do not overlap, the minimum value(s) of range(s) and/or the maximum value(s) of the range(s) are adapted so that the ranges corresponding to different object mask identifiers do not overlap.

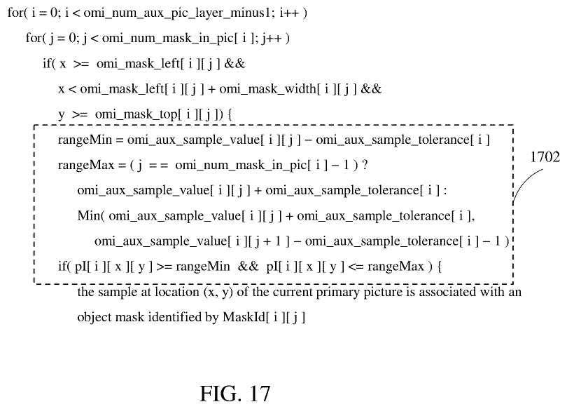

FIG. 17 shows an example semantics for adapting the maximum value of the range, in accordance to an example embodiment. Example modifications to the semantics are shown at 1702.

### Example Option 4

In an embodiment, the explicit range syntax flag is named omi_tolerance_present_flag, which gates the presence of the tolerance value, named omi_aux_sample_tolerance[i], for an object mask identifier. FIG. 18 shows at least an excerpt of an example syntax table comprising omi_tolerance_present_flag and omi_aux_sample_tolerance[i].

In an embodiment, the variables OmiAuxSampleRangeDeltaMin[i] and OmiAuxSampleRangeDeltaMax[i] are derived as follows:
OmiAuxSampleRangeDeltaMin[i]=(!omi_tolerance_present_flag)? 0: omi_aux_sample_tolerance[i]
OmiAuxSampleRangeDeltaMax[i]=(!omi_tolerance_present_flag)? 0: omi_aux_sample_tolerance[i]

In an embodiment, the range of sample values is determined by setting the minimum value of the range to the auxiliary sample value minus the tolerance value, and the maximum value to the auxiliary sample value plus the tolerance value. Consequently, according to an embodiment, when omi_tolerance_present_flag is equal to 1, the range of sample values is determined by setting the minimum value of the range to the auxiliary sample value minus OmiAuxSampleRangeDeltaMin[i], and the maximum value to the auxiliary sample value plus OmiAuxSampleRangeDeltaMax[i].

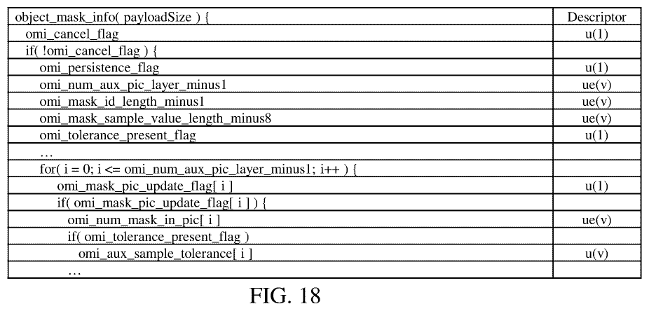

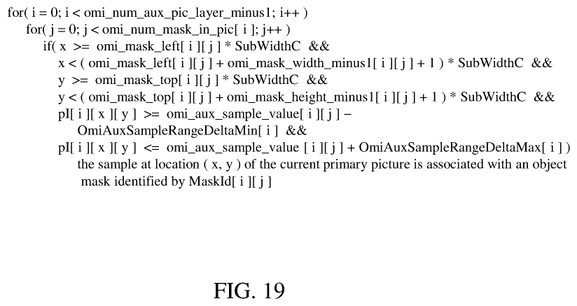

FIG. 19 shows an example implementation or pseudo-code for mapping sample values to mask identifiers.

The variable pI[i][x][y] is the decoded value of the luma sample at the relative sample location (x, y) in the cropped picture of the i-th auxiliary layer associated with the current primary layer. The mask area is determined as shown in FIG. 19:

In an embodiment, it is a requirement of bitstream conformance that when j is greater than 0, omi_aux_sample_value[i][j]−OmiAuxSampleRangeDeltaMin[i] shall be greater than omi_aux_sample_value[i][j−1]+OmiAuxSampleRangeDeltaMax[i].

### Application to Other Types of Masks

Embodiments have been described in relation to object masks. It is to be understood that embodiments may be similarly realized to other types of mask or map pictures, such as but not limited to:

### Occupancy Mask

### Segmentation Mask

Filtering mask to control post-processing (such as film grain synthesis), in-loop filtering, and/or post-filtering

Depth Map with a Constrained Number of Depth Levels

Embodiments have been described in relation to the OMI SEI message, which relates to object masks. It is to be understood that embodiment may be similarly realized with any SEI message, which relate to any other type of mask or map pictures.

It is to be understood that embodiments may be realized with an SEI message that is independent of the type of mask or map images represented by an auxiliary layer. Such an SEI message may be called discrete sample values SEI message, for example.

### Other Example Embodiments

### Bounding Box Signaling

In an embodiment, the width and height of the bounding box parameters, signaled in the object mask information message, for each object mask identifier are signaled to be one less than the actual width and height. This is to avoid a condition where a bounding box has a width and/or height of zero, which would disallow any samples being associated with the object mask identifier.

When 4:2:0 or 4:2:2 chroma format, the number of chroma samples and luma samples in a coded picture differ. The SubWidthC and SubHeightC variables indicate a ratio between the luma and chroma width and height, respectively.

In an embodiment, the mask and height of the bounding box are specified to be in units of chroma samples.

A receiver/decoder uses the bounding box parameters to restrict which sample positions may be associated with an object mask identifier. In an embodiment, the signaled width and height parameters are multiplied by SubWidthC and SubHeightC before determining if a sample position fits within the bounding box, so that the bounding box size corresponds to the scale of the luma picture samples.

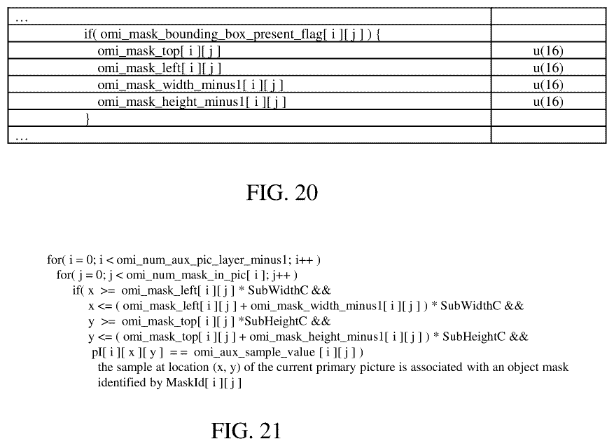

FIG. 20 shows an example implementation for signaling bounding box parameters. In this example, omi_mask_width_minus1[i][j]+1 and omi_mask_height_minus1[i][j]+1 specify the width and height, respectively, in chroma samples, of the bounding box of the object mask of the i-th object mask auxiliary layer associated with the current primary layer, in chroma samples.

Variable pI[i][x][y] is the decoded value of the luma sample at the relative sample location (x, y) in the cropped picture of the i-th auxiliary layer associated with the current primary layer.

FIG. 21 shows an example implementation for determining the mask area.

### Constraints Regarding Auxiliary Pictures and Primary Picture

A constraint is applied that all AUs comprising a primary picture where an object mask information message applies shall also include a picture in all associated object mask auxiliary layers described by the object mask information message.

Another constraint is applied that the width and height of auxiliary pictures described by an object mask information message are equal to the width and height, respectively, of their associated primary picture.

In an embodiment, the interface between the video codec specification and the information message specification includes the cropped width and height for the primary picture and all of the auxiliary pictures described by the OMI SEI message.

### Semantics in VSEI

Use of this SEI message requires the definition of the following variables:
A bit depth for the samples of the luma component, denoted herein by BitDepthY.
A cropped picture width and picture height in units of luma samples, denoted herein by CroppedWidth[lId] and CroppedHeight[lId], respectively, for lId equal to the layer identifier value of the primary layer and the layer identifier values of the associated object mask auxiliary layers.
A chroma format indicator, denoted herein by ChromaFormatIdc, which may be defined according to the following table.

| ChromaFormatIdc | Chroma format | SubWidthC | SubHeightC |
|---|---|---|---|
| 0 | Monochrome | 1 | 1 |
| 1 | 4:2:0 | 2 | 2 |
| 2 | 4:2:2 | 2 | 1 |
| 3 | 4:4:4 | 1 | 1 |

The variables SubWidthC and SubHeightC are derived from ChromaFormatIdc as specified above.

omiNumAuxLayer and omiAuxLayerId[i] are edited to be global variables OmiNumAuxLayer and OmiAuxLayer[i]. The variable omiNumAuxLayer indicate the number of object mask auxiliary layers associated with the current primary layer and the array omiAuxLayerId[i] indicate the layer identifier of the i-th object mask auxiliary layer associated with the current primary layer.

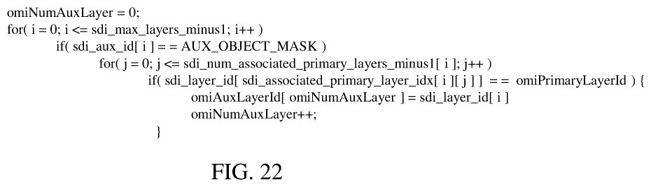

FIG. 22 shows an example implementation for deriving omiNumAuxLayer and omiAuxLayerId[i]. In this example, omiPrimaryLayerId is the layer identifier of the current primary layer.

It is a requirement of bitstream conformance that when an OMI SEI message persists for a picture picA in the current primary layer, the AU that contains picA shall include an auxiliary picture with layer identifier equal to omiAuxLayerId[i] for i in the range of 0 . . . omiNumAuxLayer−1, inclusive.

It is a requirement of bitstream conformance that the values of CroppedWidth[lId] and CroppedHeight[lId] for all lId equal to omiAuxLayerId[i] for i in the range of 0 . . . omiNumAuxLayer−1, inclusive, shall be equal to the values of CroppedWidth[omiPrimaryLayerId] and CroppedHeight[omiPrimaryLayerId], respectively.

### Semantics in VVC

For purposes of interpretation of the object mask information SEI message for an AU that includes a picture for which the OMI SEI message applies, the following variables are specified:
BitDepthY is set equal to BitDepth.
CroppedWidth[lId] for lId equal to nuh_layer_id of the SEI NAL unit that contains this SEI message or OmiAuxLayerId[i] for all values of i in the range of 0 . . . OmiNumAuxLayer−1, inclusive, is set equal to (pps_pic_width_in_luma_samples−SubWidthC*(pps_conf_win_left_offset+pps_conf_win_right_offset)) for the PPS that applies to the coded picture with nuh_layer_id equal to lId in the AU.
CroppedHeight[lId] for lId equal to nuh_layer_id of the SEI NAL unit that contains this SEI message or OmiAuxLayerId[i] for all values of i in the range of 0 . . . OmiNumAuxLayer−1, inclusive, is set equal to (pps_pic_height_in_luma_samples−SubHeightC*(pps_conf_win_top_offset+pps_conf_win_bottom_offset)) for the PPS that applies to the coded picture with nuh_layer_id equal to lId in the AU.
ChromaFormatIdc is set equal to sps_chroma_format_idc.

### Bit-Depth of Auxiliary Pictures

In an embodiment, different luma bit-depths may be used for coding the primary and the object mask auxiliary layers.

The interface between the video codec specification and the information message specification includes the luma bit-depth for the primary picture and of each object mask auxiliary picture described by the object mask information message.

### Proposed Semantics in VSEI

Use of this SEI message requires the definition of the following variables:
A bit depth for the samples of the luma component, denoted herein by BitDepth Y[lId] for lId equal to the layer identifier value of the layer identifier values of the object mask auxiliary layers associated with the primary layer.
A cropped picture width and picture height in units of luma samples, denoted herein by CroppedWidth and CroppedHeight, respectively.
A chroma format indicator, denoted herein by ChromaFormatIdc, as described previously.

omi_mask_sample_value_length_minus8 plus 8 specifies the length, in bits, of the omi_aux_sample_value[i][j] syntax element. The value of omi_mask_sample_value_length_minus8 shall be in the range of 0 to 8, inclusive. The value of omi_mask_sample_value_length_minus8 plus 8 shall be less than or equal to greatest value of BitDepthY[lId] for lId equal to omiAuxLayerId[i] among all values i in the range of 0 . . . OmiNumAuxLayer−1, inclusive.

omi_aux_sample_value[i][j] specifies the luma value of the samples corresponding to the area of the j-th object mask of the i-th object mask auxiliary layer associated with the current primary layer. The value of omi_aux_sample_value[i][j] shall be less than 1<<BitDepthY[omiAuxLayerId[i]]. These samples are bounded by the bounding box specified by the syntax elements omi_mask_top[i][j], omi_mask_left[i][j], omi_mask_width[i][j] and omi_mask_height[i][j], if present in the current SEI message. The length of the omi_aux_sample_value[i][j] syntax element is omi_mask_sample_value_length_minus8+8 bits.

### Proposed Semantics in VVC

For purposes of interpretation of the object mask information SEI message, the following variables are specified:
BitDepth Y[lId] for lId equal to OmiAuxLayerId[i] for all values of i in the range of 0 . . . OmiNumAuxLayer−1, inclusive is set equal to BitDepth derived from the SPS that applies to the CLVS with nuh_layer_id equal to lId.
CroppedWidth is set equal to (pps_pic_width_in_luma_samples SubWidthC*(pps_conf_win_left_offset+pps_conf_win_right_offset)).

CroppedHeight is set equal to (pps_pic_height_in_luma_samples−SubHeightC*(pps_conf_win_top_offset+pps_conf_win_bottom_offset)).
ChromaFormatIdc is set equal to sps_chroma_format_idc.

### Usage in a Processing Chain

In an embodiment, when an OMI SEI message type is included in a processing chain defined by an SEI processing order SEI message, it implies a property that describes the output of the previous process in the processing chain.

In an embodiment, when an OMI SEI message type is included in a processing chain defined by an SEI processing order SEI message, it implies a process wherein:
the decoded sample value is compared to the determined range of sample values for an object mask identifier, and
when the sample value is within the determined range, replaces the sample value with the corresponding sample value that corresponds to the object mask (e.g., omi_aux_sample_value[i][j])

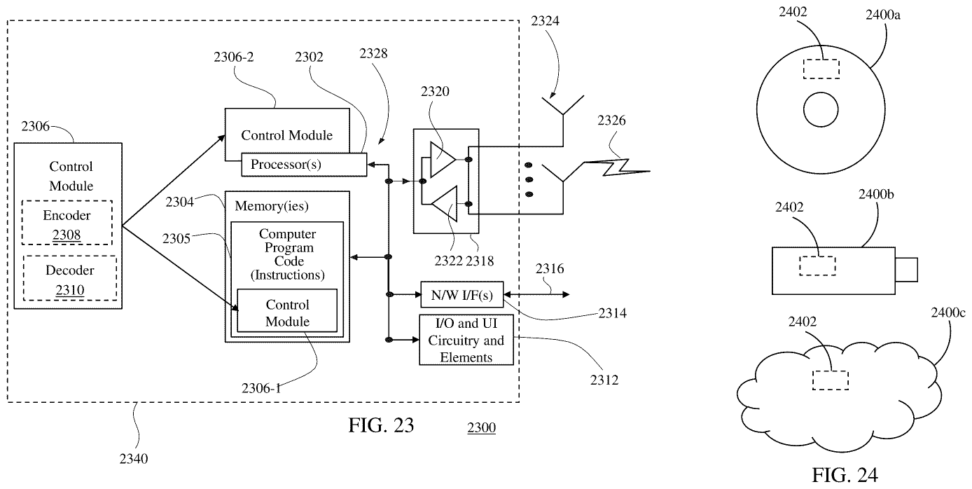

FIG. 23 is an example apparatus 2300, which may be implemented in hardware, configured to implement the examples described herein. The apparatus 2300 comprises at least one processor 2302 (e.g., an FPGA and/or CPU), at least one memory 2304 including computer program code 2305, the computer program code 2305 having instructions to carry out the methods described herein, wherein the at least one memory 2304 and the computer program code 2305 are configured to, with the at least one processor 2302, cause the apparatus 2300 to implement circuitry, a process, component, module, or function (implemented with control module 2306) to implement the examples described herein, including signaling, receiving, encoding, and/or decoding an object mask information message. Optionally included encoder 2308 of the control module 2306 implements encoding based on the examples described herein, and optionally included decoder 2310 implements decoding based on the examples described herein. The at least one memory 2304 may be a non-transitory memory, a transitory memory, a volatile memory (e.g. RAM), or a non-volatile memory (e.g., ROM).

The apparatus 2300 includes a display and/or I/O interface 2312, which includes user interface (UI) circuitry and elements, that may be used to display features or a status of the methods described herein (e.g., as one of the methods is being performed or at a subsequent time), or to receive input from a user such as with using a keypad, camera, touchscreen, touch area, microphone, biometric recognition, one or more sensors, etc. The apparatus 2300 includes one or more communication e.g. network (N/W) interfaces (I/F(s)) 2314. The communication I/F(s) 2314 may be wired and/or wireless and communicate over the Internet/other network(s) via any communication technique including via one or more links 2316. The communication I/F(s) 2314 may comprise one or more transmitters or one or more receivers.

The transceiver 2318 comprises one or more transmitters 2320 and one or more receivers 2322. The transceiver 2318 and/or communication I/F(s) 2314 may comprise standard well-known components such as an amplifier, filter, frequency-converter, (de) modulator, and encoder/decoder circuitries and one or more antennas, such as antennas 2324 used for communication over wireless link 2326.

The control module 2306 of the apparatus 2300 comprises one of or both parts 2306-1 and/or 2306-2, which may be implemented in a number of ways. The control module 2306 may be implemented in hardware as control module 2306-1, such as being implemented as part of the at least one processor 2302. The control module 2306-1 may be implemented also as an integrated circuit or through other hardware such as a programmable gate array. In another example, the control module 2306 may be implemented as control module 2306-2, which is implemented as computer program code (having corresponding instructions) 2305 and is executed by the at least one processor 2302. For instance, the at least one memory 2304 store instructions that, when executed by the at least one processor 2302, cause the apparatus 2300 to perform one or more of the operations as described herein. Furthermore, the at least one processor 2302, the at least one memory 2304, and example algorithms (e.g., as flowcharts and/or signaling diagrams), encoded as instructions, programs, or code, are means for causing performance of the operations described herein.

The apparatus 2300 to implement the functionality of control module 2306 may correspond to any of the apparatuses depicted herein. Alternatively, apparatus 2300 and its elements may not correspond to any of the other apparatuses depicted herein, as apparatus 2300 may be part of a self-organizing/optimizing network (SON) node or other node, such as a node in a cloud.

The apparatus 2300 may also be distributed throughout the network including within and between apparatus 2300 and any network element (such as a base station and/or terminal device and/or user equipment).

Interface 2328 enables data communication and signaling between the various items of apparatus 2300, as shown in FIG. 23. For example, the interface 2328 may be one or more buses such as address, data, or control buses, and may include any interconnection mechanism, such as a series of lines on a motherboard or integrated circuit, fiber optics or other optical communication equipment, and the like. Computer program code (e.g. instructions) 2305, including control module 2306 may comprise object-oriented software configured to pass data or messages between objects within computer program code 2305. The apparatus 2300 need not comprise each of the features mentioned, or may comprise other features as well. The various components of apparatus 2300 may at least partially reside in a housing 2330, or a subset of the various components of apparatus 2300 may at least partially be located in different housings, which different housings may include housing 2330.

FIG. 24 shows a schematic representation of non-volatile memory media 2400a (e.g. computer/compact disc (CD) or digital versatile disc (DVD)) and 2400b (e.g. universal serial bus (USB) memory stick) and 2400c (e.g. cloud storage for downloading instructions and/or parameters 2402 or receiving emailed instructions and/or parameters 2402) storing instructions and/or parameters 2402 which when executed by a processor allows the processor to perform one or more of the operations of the methods described herein. Instructions and/or parameters 2402 may represent or correspond to a non-transitory computer readable medium.

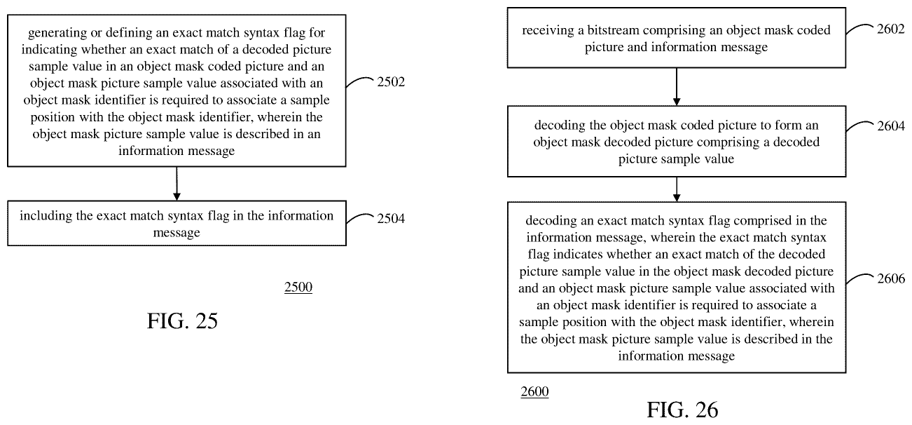

FIG. 25 is an example method 2500 performed with an encoder, based on the examples described herein. At 2502, the method 2500 includes generating or defining an exact match syntax flag for indicating whether an exact match of a decoded picture sample value in an object mask coded picture and an object mask picture sample value associated with an object mask identifier is required to associate a sample position with the object mask identifier, wherein the object mask picture sample value is described in an information message. At 2504, the method 2500 includes including the exact match syntax flag in the information message.

The method 2500 may be performed with an encoding apparatus, such as the apparatus 100, 2300, or apparatuses depicted in FIG. 3 and FIG. 4, for example, the transmitting apparatus 404 with the encoder 402, or the apparatus 400 with the encoder 402.

FIG. 26 is an example method 2600 performed with a decoder, based on the example embodiments described herein. At 2602, the method 2600 includes receiving a bitstream comprising an object mask coded picture and information message. At 2604, the method 2600 includes decoding the object mask coded picture to form an object mask decoded picture comprising a decoded picture sample value. At 2606, the method 2600 includes decoding an exact match syntax flag comprised in the information message, wherein the exact match syntax flag indicates whether an exact match of the decoded picture sample value in the object mask decoded picture and an object mask picture sample value associated with an object mask identifier is required to associate a sample position with the object mask identifier, wherein the object mask picture sample value is described in the information message.

The method 2600 may be performed with a decoding apparatus, such as the apparatus 100, 2300, or apparatuses depicted in FIG. 3 and FIG. 4, for example, the receiving apparatus 408 with the decoder 410, or the apparatus 400 with the decoder 410.

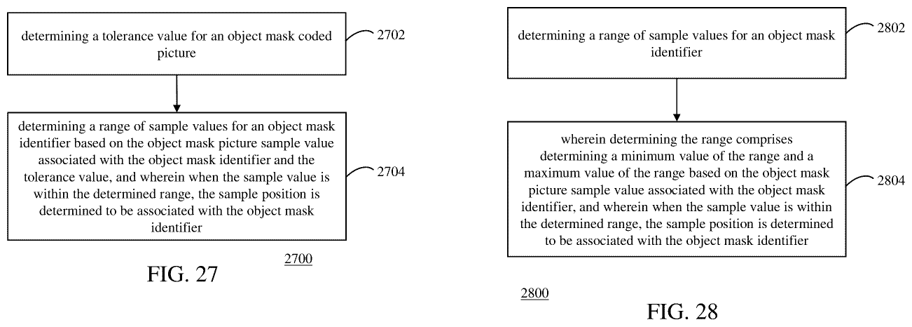

FIG. 27 is an example method 2700 performed with an encoder, based on the examples described herein. At 2702, the method 2700 includes determining a tolerance value for an object mask coded picture. At 2704, the method 2700 includes determining a range of sample values for an object mask identifier based on the object mask picture sample value associated with the object mask identifier and the tolerance value, and wherein when the sample value is within the determined range, the sample position is determined to be associated with the object mask identifier.

The method 2700 may be performed with an encoding apparatus, such as the apparatus 100, 2300, or apparatuses depicted in FIG. 3 and FIG. 4, for example, the transmitting apparatus 404 with the encoder 402, or the apparatus 400 with the encoder 402.

FIG. 28 is an example method 2800 performed with a decoder, based on the example embodiments described herein. At 2802, the method 2800 includes determining a range of sample values for an object mask identifier. At 2804, the method 2800 includes, wherein determining the range comprises: determining a minimum value of the range and a maximum value of the range based on the object mask picture sample value associated with the object mask identifier, and wherein when the sample value is within the determined range, the sample position is determined to be associated with the object mask identifier.

The method 2800 may be performed with a decoding apparatus, such as the apparatus 100, 2300, or apparatuses depicted in FIG. 3 and FIG. 4, for example, the receiving apparatus 408 with the decoder 410, or the apparatus 400 with the decoder 410.

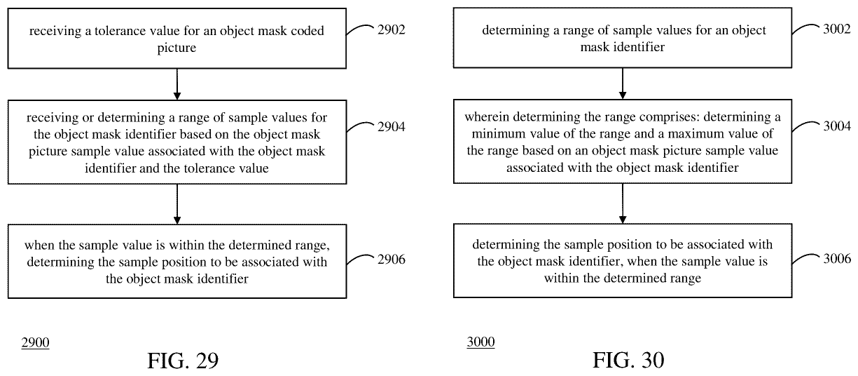

FIG. 29 is an example method 2900 performed with an encoder, based on the examples described herein. At 2902, the method 2900 includes receiving a tolerance value for an object mask coded picture. At 2904, the method 2900 includes receiving or determining a range of sample values for the object mask identifier based on the object mask picture sample value associated with the object mask identifier and the tolerance value. At 2906, the method 2900 includes when the sample value is within the determined range, determining the sample position to be associated with the object mask identifier.

The method 2900 may be performed with an encoding apparatus, such as the apparatus 100, 2300, or apparatuses depicted in FIG. 3 and FIG. 4, for example, the transmitting apparatus 404 with the encoder 402, or the apparatus 400 with the encoder 402.

FIG. 30 is an example method 3000 performed with a decoder, based on the example embodiments described herein. At 3002, the method 3000 includes determining a range of sample values for an object mask identifier. At 3004, the method 3000 includes wherein determining the range comprises: determining a minimum value of the range and a maximum value of the range based on an object mask picture sample value associated with the object mask identifier. At 3006, the method 3000 includes determining the sample position to be associated with the object mask identifier, when the sample value is within the determined range.

The method 3000 may be performed with a decoding apparatus, such as the apparatus 100, 2300, or apparatuses depicted in FIG. 3 and FIG. 4, for example, the receiving apparatus 408 with the decoder 410, or the apparatus 400 with the decoder 410.

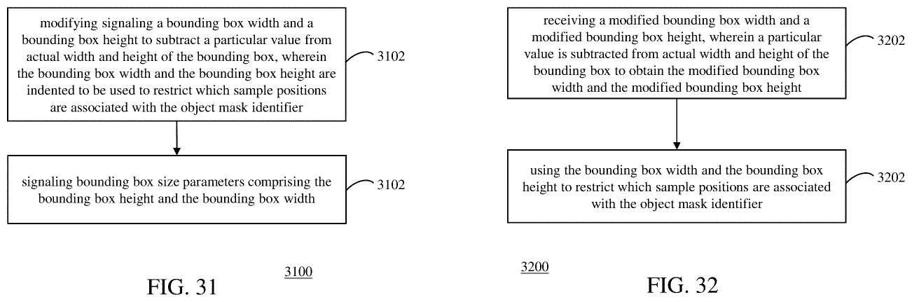

FIG. 31 is an example method 3100 performed with an encoder, based on the examples described herein. At 3102, the method 3100 includes modifying signaling a bounding box width and a bounding box height to subtract a particular value from actual width and height of the bounding box, wherein the bounding box width and the bounding box height are indented to be used to restrict which sample positions are associated with the object mask identifier. At 3104, the method 3100 includes signaling bounding box size parameters comprising the bounding box height and the bounding box width.

The method 3100 may be performed with an encoding apparatus, such as the apparatus 100, 2300, or apparatuses depicted in FIG. 3 and FIG. 4, for example, the transmitting apparatus 404 with the encoder 402, or the apparatus 400 with the encoder 402.

FIG. 32 is an example method 3200 performed with a decoder, based on the example embodiments described herein. At 3202, the method 3200 includes receiving a modified bounding box width and a modified bounding box height, wherein a particular value is subtracted from actual width and height of the bounding box to obtain the modified bounding box width and the modified bounding box height. At 3202, the method 3200 includes using the bounding box width and the bounding box height to restrict which sample positions are associated with the object mask identifier.

The method 3200 may be performed with a decoding apparatus, such as the apparatus 100, 2300, or apparatuses depicted in FIG. 3 and FIG. 4, for example, the receiving apparatus 408 with the decoder 410, or the apparatus 400 with the decoder 410.

As described above, FIGS. 25 and 32 include flowcharts of an apparatus (e.g. 100, 400, 2300, or any other apparatuses described herein), method, and computer program product according to certain example embodiments. It will be understood that each block of the flowcharts, and combinations of blocks in the flowcharts, may be implemented by various means, such as hardware, firmware, processor, circuitry, and/or other devices associated with execution of software including one or more computer program instructions. For example, one or more of the procedures described above may be embodied by computer program instructions. In this regard, the computer program instructions which embody the procedures described above may be stored by a memory (e.g. 112 or 2304) of an apparatus employing an embodiment of the present invention and executed by processing circuitry (e.g., 110 or 2302) of the apparatus. As will be appreciated, any such computer program instructions may be loaded onto a computer or other programmable apparatus (e.g., hardware) to produce a machine, such that the resulting computer or other programmable apparatus implements the functions specified in the flowchart blocks. These computer program instructions may also be stored in a computer-readable memory that may direct a computer or other programmable apparatus to function in a particular manner, such that the instructions stored in the computer-readable memory produce an article of manufacture, the execution of which implements the function specified in the flowchart blocks. The computer program instructions may also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flowchart blocks.

A computer program product is therefore defined in those instances in which the computer program instructions, such as computer-readable program code portions, are stored by at least one non-transitory computer-readable storage medium with the computer program instructions, such as the computer-readable program code portions, being configured, upon execution, to perform the functions described above, such as in conjunction with the flowchart(s) of FIGS. 25 and 32. In other embodiments, the computer program instructions, such as the computer-readable program code portions, need not be stored or otherwise embodied by a non-transitory computer-readable storage medium, but may, instead, be embodied by a transitory medium with the computer program instructions, such as the computer-readable program code portions, still being configured, upon execution, to perform the functions described above.

Accordingly, blocks of the flowcharts support combinations of means for performing the specified functions and combinations of operations for performing the specified functions for performing the specified functions. It will also be understood that one or more blocks of the flowcharts, and combinations of blocks in the flowcharts, may be implemented by special purpose hardware-based computer systems which perform the specified functions, or combinations of special purpose hardware and computer instructions.

In some embodiments, certain ones of the operations above may be modified or further amplified. Furthermore, in some embodiments, additional optional operations may be included. Modifications, additions, or amplifications to the operations above may be performed in any order and in any combination.

Some example embodiments have been described in relation to specific terms applicable to a particular format or standard. It is to be understood that embodiments may be similarly realized with any terms with similar semantics. For example, some embodiments have been described in relation to one or more SEI messages, but embodiments may be similarly realized with one or more metadata OBUs.

In the above, some example embodiments have been described with the help of syntax of the bitstream. It needs to be understood, however, that the corresponding structure and/or computer program may reside at the encoder for generating the bitstream and/or at the decoder for decoding the bitstream.

In the above, where example embodiments have been described with reference to an encoder, it needs to be understood that the resulting bitstream and the decoder have corresponding elements in them. Likewise, where example embodiments have been described with reference to a decoder, it needs to be understood that the encoder has structure and/or computer program for generating the bitstream to be decoded by the decoder.

Some example embodiments have been described in relation to requirements of bitstream conformance. It is to be understood that the embodiments apply to an encoder that outputs a bitstream and has corresponding elements to realize the requirements of bitstream conformance. Furthermore, it is to be understood that embodiments apply to an entity that verifies the correctness of a bitstream and has corresponding elements to check whether the requirements of bitstream conformance are fulfilled.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Accordingly, the description is intended to embrace all such alternatives, modifications and variances which fall within the scope of the appended claims. Although specific terms are employed herein, they are used in a generic and descriptive sense only and not for purposes of limitation.

It should be understood that the foregoing description is only illustrative. Various alternatives and modifications may be devised by those skilled in the art. For example, features recited in the various dependent claims could be combined with each other in any suitable combination(s). In addition, features from different embodiments described above could be selectively combined into a new embodiment. Accordingly, the description is intended to embrace all such alternatives, modifications and variances which fall within the scope of the appended claims.

References to a ‘computer’, ‘processor’, etc. should be understood to encompass not only computers having different architectures such as single/multi-processor architectures and sequential (Von Neumann)/parallel architectures but also specialized circuits such as field-programmable gate arrays (FPGA), application specific circuits (ASIC), signal processing devices and other processing circuitry. References to computer program, instructions, code etc. should be understood to encompass software for a programmable processor or firmware such as, for example, the programmable content of a hardware device such as instructions for a processor, or configuration settings for a fixed-function device, gate array or programmable logic device, and the like.

As used herein, the term ‘circuitry’ may refer to any of the following: (a) hardware circuit implementations, such as implementations in analog and/or digital circuitry, and (b) combinations of circuits and software (and/or firmware), such as (as applicable): (i) a combination of processor(s) or (ii) portions of processor(s)/software including digital signal processor(s), software, and memory(ies) that work together to cause an apparatus to perform various functions, and (c) circuits, such as a microprocessor(s) or a portion of a microprocessor(s), that require software or firmware for operation, even when the software or firmware is not physically present. This description of ‘circuitry’ applies to uses of this term in this application. As a further example, as used herein, the term ‘circuitry’ would also cover an implementation of merely a processor (or multiple processors) or a portion of a processor and its (or their) accompanying software and/or firmware. The term ‘circuitry’ would also cover, for example and when applicable to the particular element, a baseband integrated circuit or applications processor integrated circuit for a mobile phone or a similar integrated circuit in a server, a cellular network device, or another network device.

Circuitry or Circuit: As used in this application, the term ‘circuitry’ or ‘circuit’ may refer to one or more or all of the following:
(a) hardware-only circuit implementations (such as implementations in only analog and/or digital circuitry); and
(b) combinations of hardware circuits and software, such as (as applicable):
   (i) a combination of analog and/or digital hardware circuit(s) with software/firmware; and
   (ii) any portions of hardware processor(s) with software (including digital signal processor(s)), software, and memory (ies) that work together to cause an apparatus, such as a mobile phone or server, to perform various functions); and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example, and when applicable to the particular claim element, a baseband integrated circuit or processor integrated circuit for a mobile device or a similar integrated circuit in server, a cellular network device, or other computing or network device.

1-95. (canceled)

96. An apparatus comprising:
at least one processor; and
at least one memory storing instructions that, when executed by the at least one processor, cause the apparatus at least to perform:
generating or defining an exact match syntax flag for indicating whether an exact match of a decoded picture sample value in an object mask coded picture and an object mask picture sample value associated with an object mask identifier is required to associate a sample position with the object mask identifier, wherein the object mask picture sample value is described in an information message; and
including the exact match syntax flag in the information message.

97. The apparatus of claim 96, wherein the apparatus is further caused to perform:
determining an object mask of an object to represent an auxiliary picture;
assigning the object mask identifier for the object;
determining the object mask picture sample value associated with the object mask identifier;
forming an object mask source picture, in which a sample value of the sample position associated with the object mask is set to the object mask picture sample value;
encoding the object mask source picture to form the object mask coded picture; and
including the object mask coded picture and the information message in an bitstream.

98. The apparatus of claim 96, wherein when the exact match syntax flag comprises a first value for indicating the exact match, and wherein when the decoded picture sample value is equal to the object mask picture sample value, the sample position is determined to be associated with the object mask identifier.

99. The apparatus of claim 96, wherein when the exact match syntax flag is set to a second value that does not indicate the exact match, and wherein the apparatus is further caused to perform:
determining a tolerance value for the object mask coded picture; and
determining a range of sample values for the object mask identifier based on the object mask picture sample value and the tolerance value, and wherein when a sample value is within the determined range, the sample position is determined to be associated with the object mask identifier.

100. The apparatus of claim 99, wherein to determine the range of sample values for the object mask identifier, and wherein the apparatus is further caused to perform:
setting a minimum value of a range to the object mask picture sample value minus the tolerance value; and
setting a maximum value of the range to the object mask picture sample value plus the tolerance value.

101. The apparatus of claim 100, wherein the apparatus is further caused to perform: limiting the object mask picture sample value and the tolerance value ranges corresponding to different object mask identifiers to not overlap.

102. The apparatus of claim 101, wherein the apparatus is further caused to perform: signaling one of the following:
the tolerance value per auxiliary picture layer, wherein an auxiliary layer comprises an auxiliary picture;
the tolerance value per object mask identifier value in the auxiliary picture layer; or
a single tolerance value for all auxiliary picture layers associated with a primary layer, wherein the primary layer comprises a primary picture.

103. An apparatus comprising:
at least one processor; and
at least one memory storing instructions that, when executed by the at least one processor, cause the apparatus at least to perform:
receiving a bitstream comprising an object mask coded picture and information message;
decoding the object mask coded picture to form an object mask decoded picture comprising a decoded picture sample value; and
decoding an exact match syntax flag comprised in the information message, wherein the exact match syntax flag indicates whether an exact match of the decoded picture sample value in the object mask decoded picture and an object mask picture sample value associated with an object mask identifier is required to associate a sample position with the object mask identifier, wherein the object mask picture sample value is described in the information message.

104. The apparatus of claim 103, wherein the apparatus is further caused to perform:
comparing the decoded picture sample value to the object mask picture sample value described in the information message; and
determining the sample position to be associated with the object mask identifier when the exact match syntax flag comprises a first value for indicating the exact match and when the decoded picture sample value is equal to the object mask picture sample value.

105. The apparatus of claim 103, wherein when the exact match syntax flag is set to a second value that does not indicate the exact match, and wherein the apparatus is further caused to perform:
receiving a tolerance value for the object mask coded picture;
receiving or determining a range of sample values for the object mask identifier based on the object mask picture sample value and the tolerance value; and
when a sample value is within the determined range, determining the sample position to be associated with the object mask identifier.

106. The apparatus of claim 105, wherein to determine the range of sample values for the object mask identifier, and wherein the apparatus is further caused to perform:
setting a minimum value of a range to the object mask picture sample value minus the tolerance value; and
setting a maximum value of the range to the object mask picture sample value plus the tolerance value.

107. The apparatus of claim 106, wherein the object mask picture sample value and the tolerance value are constrained so that ranges corresponding to different object mask identifiers do not overlap.

108. The apparatus of claim 107, wherein the apparatus is further caused to perform: receiving one of the following:
the tolerance value per auxiliary picture layer, wherein an auxiliary layer comprises an auxiliary picture;
the tolerance value per object mask identifier value in the auxiliary picture layer; or
a single tolerance value for all auxiliary picture layers associated with a primary layer, wherein the primary layer comprises a primary picture.

109. A method comprising:
generating or defining an exact match syntax flag for indicating whether an exact match of a decoded picture sample value in an object mask coded picture and an object mask picture sample value associated with an object mask identifier is required to associate a sample position with the object mask identifier, wherein the object mask picture sample value is described in an information message; and
including the exact match syntax flag in the information message.

110. A method comprising:
receiving a bitstream comprising an object mask coded picture and information message;
decoding the object mask coded picture to form an object mask decoded picture comprising a decoded picture sample value; and
decoding an exact match syntax flag comprised in the information message, wherein the exact match syntax flag indicates whether an exact match of the decoded picture sample value in the object mask decoded picture and an object mask picture sample value associated with an object mask identifier is required to associate a sample position with the object mask identifier, wherein the object mask picture sample value is described in the information message.

111. The method of claim 110 further comprising:
comparing the decoded picture sample value to the object mask picture sample value described in the information message; and
determining the sample position to be associated with the object mask identifier when the exact match syntax flag comprises a first value for indicating the exact match and when the decoded picture sample value is equal to the object mask picture sample value.

112. The method of claim 110, wherein when the exact match syntax flag is set to a second value that does not indicate the exact match, and wherein the method further comprises:
receiving a tolerance value for the object mask coded picture;
receiving or determining a range of sample values for the object mask identifier based on the object mask picture sample value and the tolerance value; and
when a sample value is within the determined range, determining the sample position to be associated with the object mask identifier.

113. The method of claim 112, wherein to determine the range of sample values for the object mask identifier, and wherein the method is further comprises:
setting a minimum value of a range to the object mask picture sample value minus the tolerance value; and
setting a maximum value of the range to the object mask picture sample value plus the tolerance value.

114. The method of claim 113, wherein the object mask picture sample value and the tolerance value are constrained so that ranges corresponding to different object mask identifiers do not overlap.

115. The method of claim 114 further comprising: receiving one of the following:
the tolerance value per auxiliary picture layer, wherein an auxiliary layer comprises an auxiliary picture;
the tolerance value per object mask identifier value in the auxiliary picture layer; or
a single tolerance value for all auxiliary picture layers associated with a primary layer, wherein the primary layer comprises a primary picture.
